(19) United States
(12) Patent Application Publication
(10) Pub. No.: US 2026/0091575 A1
(43) Pub. Date: Apr. 2, 2026

(54) Liquid Ejecting Head And Liquid Ejecting Apparatus

(71) Applicant: SEIKO EPSON CORPORATION, Tokyo (JP)

(72) Inventors: Shingo TOMIMATSU, Shiojiri (JP); Takahiro KANEGAE, Shiojiri (JP); Yu SHIOZAWA, Minamiminowa (JP); Toshimichi YAMADA, Chino (JP); Tomonori YAMADA, Shiojiri (JP)

(21) Appl. No.: 19/342,811

(22) Filed: Sep. 29, 2025

(30) Foreign Application Priority Data
Sep. 30, 2024 (JP) 2024-170132

(51) Int. Cl. B41J 2/045; B41J 2/14; B41J 2/18; B41J 2/20

(52) U.S. Cl. CPC B41J 2/04508; B41J 2/0453; B41J 2/04581; B41J 2/14233; B41J 2/18; B41J 2/20; B41J 2002/14306

(57) ABSTRACT

A liquid ejecting head includes a plurality of nozzles that eject a liquid, a plurality of pressure chambers to which a pressure for ejecting the liquid from each of the plurality of nozzles is applied and that are arranged in a first direction, a first liquid chamber disposed in the first direction with respect to a first pressure chamber located at an end of the plurality of pressure chambers in the first direction, a first vibration plate that defines a portion of the first liquid chamber, a manifold commonly coupled to the plurality of pressure chambers and the first liquid chamber, and a strain gauge for acquiring a pressure within the first liquid chamber, the strain gauge corresponding to the first vibration plate.

The present application is based on, and claims priority from JP Application Serial Number 2024-170132, filed Sep. 30, 2024, the disclosure of which is hereby incorporated by reference herein in its entirety.

### BACKGROUND

### 1. Technical Field

The present disclosure relates to a liquid ejecting head and a liquid ejecting apparatus that eject a liquid from nozzles, and particularly, to an ink jet recording head and an ink jet recording apparatus that eject ink as a liquid.

### 2. Related Art

A liquid ejecting apparatus represented by an ink jet recording apparatus, such as an ink jet printer or plotter, includes a liquid ejecting head that is capable of ejecting a liquid, such as ink stored in a cartridge, a tank or the like, as liquid droplets.

For example, the liquid ejecting head disclosed in JP-A-2007-261285 includes a nozzle that ejects a liquid, a pressure chamber that communicates with the nozzle, and pressure detectors provided individually for a plurality of pressure chambers. The pressure detector makes it possible to measure the pressure of the liquid (meniscus) in the vicinity of the pressure chamber.

In such a related art, since the pressure detectors individually corresponding to all the pressure chambers are provided, it is possible to detect whether or not the pressure of the meniscus of each nozzle is normally maintained within the range of the meniscus withstand pressure. However, when the pressure of the meniscus in the vicinity of all the pressure chambers is measured individually, the cost increases and the size of the liquid ejecting head also increases. It is desirable to be able to detect whether or not the pressure of the meniscus of a nozzle provided in a liquid ejecting head is within a normal range while suppressing increases in cost and size.

### SUMMARY

According to an aspect of the present disclosure, there is provided a liquid ejecting head including a plurality of nozzles that eject a liquid, a plurality of pressure chambers to which a pressure for ejecting the liquid from each of the plurality of nozzles is applied and that are arranged in a first direction, a first liquid chamber disposed in the first direction with respect to a first pressure chamber located at an end of the plurality of pressure chambers in the first direction, a first vibration plate that defines a portion of the first liquid chamber, a first common liquid chamber commonly coupled to the plurality of pressure chambers and the first liquid chamber, and a first detection element for acquiring a pressure within the first liquid chamber, the first detection element corresponding to the first vibration plate.

According to another aspect of the present disclosure, there is provided a liquid ejecting apparatus including the liquid ejecting head according to the above aspect, and a pressure acquisition section that acquires the pressure of the first liquid chamber based on a resistance value of the first detection element.

### BRIEF DESCRIPTION OF THE DRAWINGS

FIG. 1 is a diagram showing a schematic configuration of a liquid ejecting apparatus according to a first embodiment.

FIG. 2 is a block diagram of the liquid ejecting apparatus according to the first embodiment.

FIG. 3 is an exploded perspective view of a liquid ejecting head according to the first embodiment.

FIG. 4 is a cross-sectional view of the liquid ejecting head according to the first embodiment.

FIG. 5 is an exploded perspective view of a head chip according to the first embodiment.

FIG. 6 is a plan view of the head chip according to the first embodiment.

FIG. 7 is a cross-sectional view taken along line VII-VII in FIG. 6 according to the first embodiment.

FIG. 8 is a cross-sectional view taken along line VIII-VIII in FIG. 6 according to the first embodiment.

FIG. 9 is a plan view showing a flow path of the head chip according to the first embodiment.

FIG. 10 is a diagram showing an example of a strain gauge and a pressure detection section according to the first embodiment.

FIG. 11 is a sectional view of a main portion of a head chip according to a first modification example of the first embodiment.

FIG. 12 is a plan view showing a flow path of a head chip according to a second modification example of the first embodiment.

FIG. 13 is a diagram showing an example of a strain gauge and a pressure detection section according to a third modification example of the first embodiment.

FIG. 14 is a block diagram of a liquid ejecting apparatus according to a sixth modification example of the first embodiment.

FIG. 15 is a plan view showing a flow path of a head chip according to a second embodiment.

FIG. 16 is a cross-sectional view taken along line XVI-XVI in FIG. 15 according to the second embodiment.

FIG. 17 is a cross-sectional view taken along line XVII-XVII in FIG. 15 according to the second embodiment.

### DESCRIPTION OF EMBODIMENTS

The present disclosure will be described in detail below based on embodiments. However, the following description shows one aspect of the present disclosure, and can be modified as desired within the scope of the present disclosure. In each drawing, the same reference numerals indicate the same members, and the description thereof will be omitted as appropriate. In each drawing, X, Y, and Z represent three spatial axes that are orthogonal to each other. In the present specification, the directions along these axes are referred to as an X direction, a Y direction, and a Z direction. In each drawing, a direction indicated by the arrow is a positive (+) direction, and a direction opposite to the arrow is a negative (−) direction. The Z direction indicates a vertical direction, the +Z direction indicates a vertically downward direction, and the −Z direction indicates a vertically upward direction. Furthermore, the directions of the three spatial axes, which are not limited to the positive direction and the negative direction, will be described as an X-axis direction, a Y-axis direction, and a Z-axis direction.

### First Embodiment

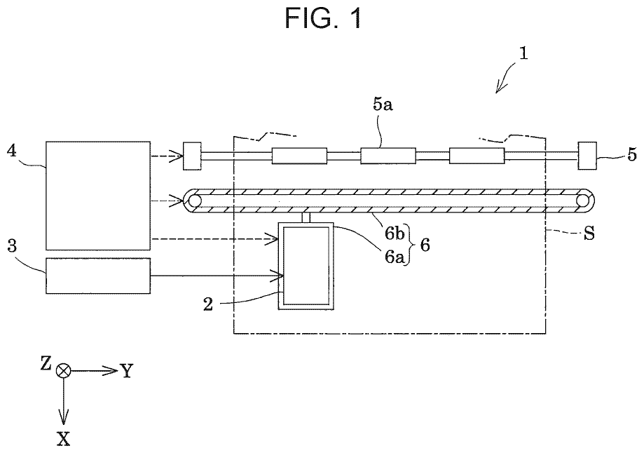

FIG. 1 is a diagram showing a schematic configuration of a liquid ejecting apparatus 1 of the present disclosure.

As shown in FIG. 1, the liquid ejecting apparatus 1 is a so-called serial printer that includes a liquid ejecting head 2 and performs printing by ejecting a liquid from the liquid ejecting head 2 toward a medium S in the +Z direction while transporting the medium S in the X-axis direction and reciprocating the liquid ejecting head 2 in the Y-axis direction. As the medium S, in addition to recording paper, any material such as a resin film or cloth can be used.

The liquid ejecting apparatus 1 includes a liquid ejecting head 2, a liquid storage portion 3, a control unit 4, a transport mechanism 5 that feeds out a medium S, and a moving mechanism 6.

The liquid ejecting head 2 ejects ink, which is an example of a liquid, supplied from the liquid storage portion 3 as ink droplets in the +Z direction.

The liquid storage portion 3 stores the ink ejected from the liquid ejecting head 2. Examples of the liquid storage portion 3 include a cartridge that is attachable to and detachable from the liquid ejecting apparatus 1, a bag-shaped ink pack made of a flexible film, and an ink tank that can be replenished with ink. Although not particularly shown, the liquid storage portion 3 stores, for example, a plurality of types of ink having different colors, components, and the like, individually. Furthermore, the liquid storage portion 3 may be divided into a main tank and a sub-tank. The sub-tank may be coupled to the liquid ejecting head 2, and ink consumed by ejecting ink from the liquid ejecting head 2 may be replenished from the main tank to the sub-tank. Furthermore, the ink may be circulated between the liquid storage portion 3 and the liquid ejecting head 2.

The control unit 4 includes, for example, a control device such as a central processing unit (CPU) or a field programmable gate array (FPGA), and a storage device such as a semiconductor memory. The control unit 4 also includes a power supply device that supplies power supplied from an external power supply such as a commercial power supply to each element of the liquid ejecting apparatus 1. The control unit 4 is electrically coupled to the liquid ejecting head 2 via an external wiring (not shown). The control unit 4 comprehensively controls each element of the liquid ejecting apparatus 1 by the control device executing a program stored in the storage device.

The transport mechanism 5 transports the medium S in the X-axis direction, and has, for example, a transport roller 5a that is rotated by a transport motor that is driven under the control of the control unit 4.

The moving mechanism 6 is a mechanism for reciprocating the liquid ejecting head 2 in the Y-axis direction, and includes a holder 6a, which is a so-called carriage that holds the liquid ejecting head 2 and a transport belt 6b that is an endless belt erected along the Y-axis direction. The control unit 4 rotates the transport belt 6b by controlling the drive of a transport motor (not shown) to reciprocate the liquid ejecting head 2 in the Y-axis direction together with the holder 6a fixed to the transport belt 6b.

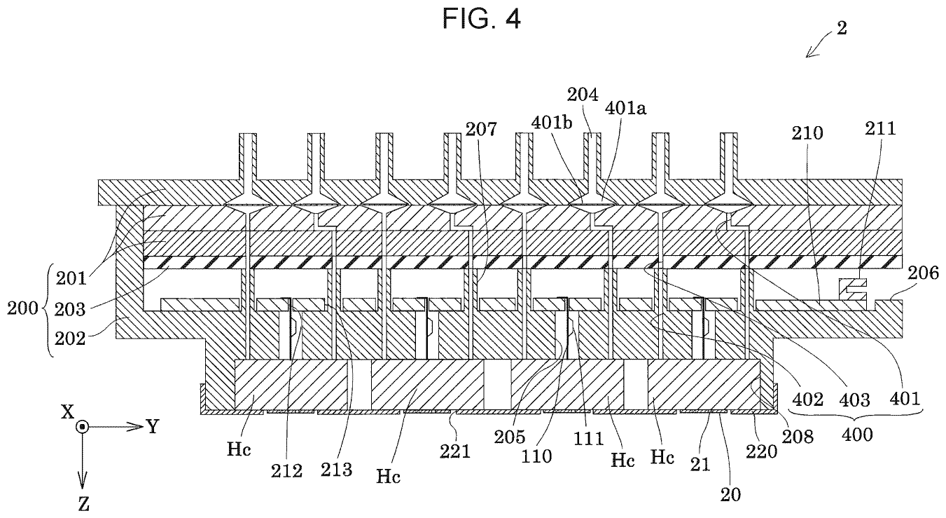

Under the control of the control unit 4, the liquid ejecting head 2 executes an ejection operation of ejecting the ink supplied from the liquid storage portion 3 in the +Z direction as ink droplets from each of a plurality of nozzles 21 (refer to FIG. 4). The ejection operation by the liquid ejecting head 2 is performed in parallel with the transporting of the medium S by the transport mechanism 5 and the reciprocating movement of the liquid ejecting head 2 by the moving mechanism 6, so that so-called printing in which the ink is applied to the medium S is performed.

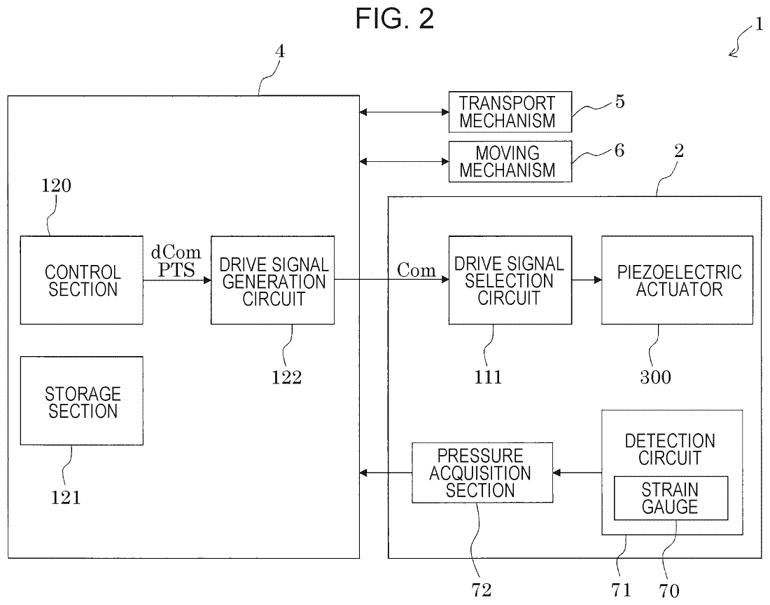

FIG. 2 is a block diagram of the liquid ejecting apparatus 1. As shown in FIG. 2, the liquid ejecting apparatus 1 includes the control unit 4, the transport mechanism 5, the moving mechanism 6, and the liquid ejecting head 2. The control unit 4 includes a control section 120, a storage section 121, and a drive signal generation circuit 122. The liquid ejecting head 2 includes a drive signal selection circuit 111, a plurality of piezoelectric actuators 300, a pressure acquisition section 72, a detection circuit 71, and a strain gauge 70.

The control section 120 includes, for example, one or more processing circuits such as a CPU or an FPGA. The control section 120 generates a signal for controlling the operation of each section of the liquid ejecting apparatus 1. The control section 120 controls the ink ejection operation by the liquid ejecting head 2.

The control section 120 generates a print signal SI, a waveform designation signal dCom, and a timing signal PTS. The print signal SI is a digital signal for designating the type of operation of the liquid ejecting head 2. The print signal SI designates whether or not to supply the drive signal Com to the piezoelectric actuator 300. The waveform designation signal dCom is a digital signal that defines a waveform of the drive signal Com. The drive signal Com is an analog signal for driving the piezoelectric actuator 300. The timing signal PTS is a signal that defines a generation timing of the drive signal Com.

The storage section 121 includes one or more storage circuits such as a semiconductor memory. The storage section 121 stores print data Img supplied from a host computer. The storage section 121 stores a control program of the liquid ejecting apparatus 1.

The drive signal generation circuit 122 includes a DA conversion circuit. The drive signal generation circuit 122 generates the drive signal Com having a waveform defined by the waveform designation signal dCom. The drive signal generation circuit 122 outputs the drive signal Com each time the timing signal PTS is received.

The drive signal selection circuit 111 switches whether or not to supply the drive signal Com to each piezoelectric actuator 300 based on the print signal SI. The drive signal selection circuit 111 selects the piezoelectric actuator 300 to which the drive signal Com is supplied, based on the print signal SI, the latch signal LAT, and a change signal CH supplied from the control unit 4. The latch signal LAT defines a latch timing of print data Img. The change signal CH defines a selection timing of a drive pulse included in the drive signal Com.

The pressure acquisition section 72 acquires the pressures in a first liquid chamber 81 and a second liquid chamber 82 (described later) based on the resistance value of the strain gauge 70 provided in the detection circuit 71.

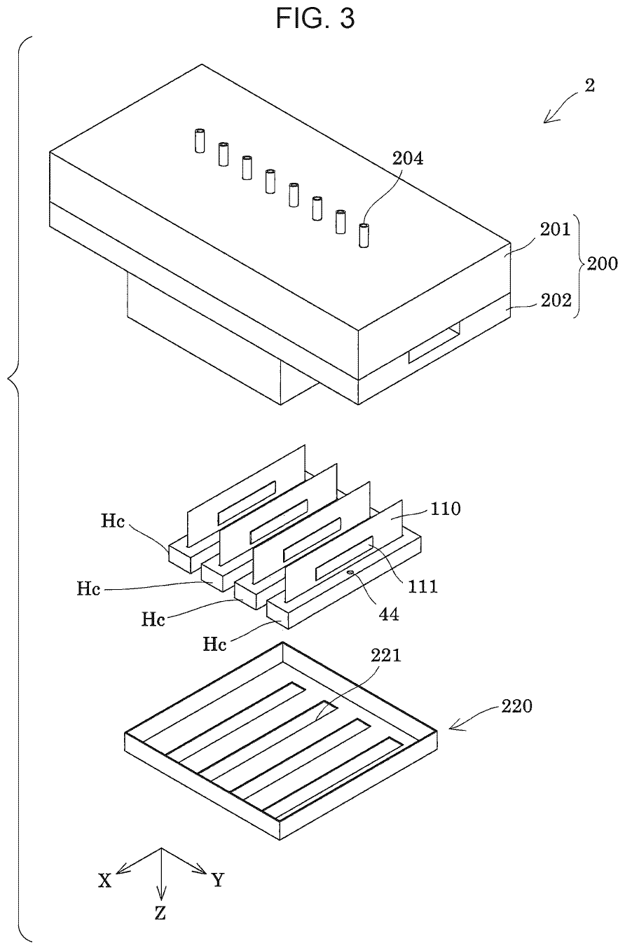

FIG. 3 is an exploded perspective view of the liquid ejecting head. FIG. 4 is a cross-sectional view of the liquid ejecting head. The directions of the liquid ejecting head 2 will be described based on the directions when the liquid ejecting head 2 is mounted on the liquid ejecting apparatus 1, that is, the X-axis direction, the Y-axis direction, and the Z-axis direction. The liquid ejecting head 2 according to the present embodiment includes a plurality of head chips Hc, a flow path member 200, a relay substrate 210, and a cover head 220.

The flow path member 200 includes a first flow path member 201 provided with a first flow path 401, a second flow path member 202 provided with a second flow path 402, and a sealing member 203 that couples the first flow path 401 and the second flow path 402 to each other in a liquid-tight state. The first flow path member 201, the sealing member 203, and the second flow path member 202 are stacked in the +Z direction in this order.

In the present embodiment, the first flow path member 201 is configured by stacking three members in the Z-axis direction. The first flow path member 201 includes a coupling portion 204 coupled to the liquid storage portion 3 in which a liquid is stored. In the present embodiment, the coupling portion 204 is provided to protrude in a tubular shape in the −Z direction from the surface of the first flow path member 201 in the −Z direction. The liquid storage portion 3 may be directly coupled to the coupling portion 204 or may be coupled via a supply pipe or the like such as a tube. The first flow path 401 to which the liquid from the liquid storage portion 3 is supplied is provided inside the coupling portion 204. The first flow path 401 includes a flow path extending in the Z-axis direction, a flow path extending along a stacking interface of the stacked members, and the like. In addition, a widened liquid reservoir 401a having an inner diameter wider than other regions is provided in the middle of the first flow path 401. A filter 401b is provided in the liquid reservoir 401a. In the present embodiment, one first flow path member 201 includes eight coupling portions 204 and eight independent first flow paths 401.

The second flow path member 202 includes a plurality of second flow paths 402 that communicate with the respective end portions of a plurality of first flow paths 401 on the side opposite to the coupling portions 204. That is, in the present embodiment, one second flow path member 202 includes eight independent second flow paths 402. The first flow path 401 and the second flow path 402 are liquid-tightly coupled to each other via the sealing member 203. For the sealing member 203, a material which has liquid resistance to the liquid used in the liquid ejecting head 2 and is elastically deformable, for example, a rubber, elastomer or the like may be used. Such a sealing member 203 is provided with a coupling flow path 403 penetrating in the Z-axis direction. The first flow path 401 and the second flow path 402 communicate with each other via the coupling flow path 403. That is, the flow path member 200 is provided with eight independent flow paths 400 including the first flow path 401, the second flow path 402, and the coupling flow path 403.

The plurality of head chips Hc are held on the surface of the second flow path member 202 facing the +Z direction. Specifically, the second flow path member 202 includes an accommodation portion 208 having a recessed shape that opens on the surface facing the +Z direction, and the head chip Hc is accommodated in the accommodation portion 208. The liquid ejecting head 2 in the present embodiment holds a plurality of head chips, and in the present embodiment, the liquid ejecting head 2 holds four head chips Hc as an example. In the present embodiment, the four head chips Hc are arranged in parallel in the Y-axis direction to be located at the same position in the X-axis direction.

In the present embodiment, a configuration in which one accommodation portion 208 is provided in common to all the head chips Hc is described, but the present disclosure is not particularly limited thereto. For example, the accommodation portion 208 may be provided independently for each head chip Hc, or may be independently provided for each group of a plurality (two or more) of head chips Hc.

The second flow path 402 communicates with each inlet 44 of the head chip Hc.

The second flow path member 202 is provided with a wiring insertion hole 205 for inserting a wiring member 110 of each head chip Hc. In the present embodiment, one wiring insertion hole 205 is provided for each head chip Hc. That is, in the present embodiment, four wiring insertion holes 205 in total are provided for the four head chips Hc. The wiring member 110 of the head chip Hc flows out to the surface side of the second flow path member 202 facing the −Z direction via the wiring insertion hole 205.

In the Z-axis direction, the relay substrate 210 to which the wiring members 110 of the plurality of head chips Hc are commonly coupled is provided between the second flow path member 202 and the sealing member 203. The relay substrate 210 is formed of a hard rigid substrate with no flexibility. Wirings, electronic components, and the like (not shown) are mounted on the relay substrate 210. In the present embodiment, as an electronic component, a connector 211 to which an external wiring (not shown) provided outside the liquid ejecting head 2 is coupled is shown. A print signal and the like for controlling the head chip Hc are input to the relay substrate 210 from the external wiring via the connector 211, and are supplied from the relay substrate 210 to each head chip Hc. An external wiring opening portion 206 for inserting an external wiring coupled to the connector 211 is provided on the side wall of the flow path member 200 that faces the connector 211. The external wiring is coupled to the connector 211 of the relay substrate 210, which is provided inside the flow path member 200, via the external wiring opening portion 206.

The relay substrate 210 is provided with a wiring insertion hole 212 for flowing out the wiring member 110 of the head chip Hc to the surface side facing the −Z direction. One wiring insertion hole 212 is provided for each head chip Hc, and four wiring insertion holes 212 in total are provided.

In addition, the relay substrate 210 is provided with a protrusion portion insertion hole 213 provided to penetrate the relay substrate 210 in the Z-axis direction. A protrusion portion 207 in which the second flow path 402 is provided is provided on the surface of the second flow path member 202 facing the −Z direction to protrude in the −Z direction. The protrusion portion 207 is inserted in the −Z direction side of the relay substrate 210 via the protrusion portion insertion hole 213, and thus is coupled to the coupling flow path 403.

The cover head 220 is fixed to a surface of the flow path member 200 facing the +Z direction. The cover head 220 defines a space of the accommodation portion 208 that accommodates the head chip Hc. In the present embodiment, the cover head 220 has a size enough for covering four head chips Hc. The cover head 220 is a common member fixed to the surfaces of the four head chips Hc facing the +Z direction. In addition, the cover head 220 is provided with an exposure opening portion 221 that exposes a nozzle 21 of the head chip Hc in the +Z direction independently for each head chip Hc. An ink is ejected from the nozzle 21 exposed from the exposure opening portion 221 in the +Z direction.

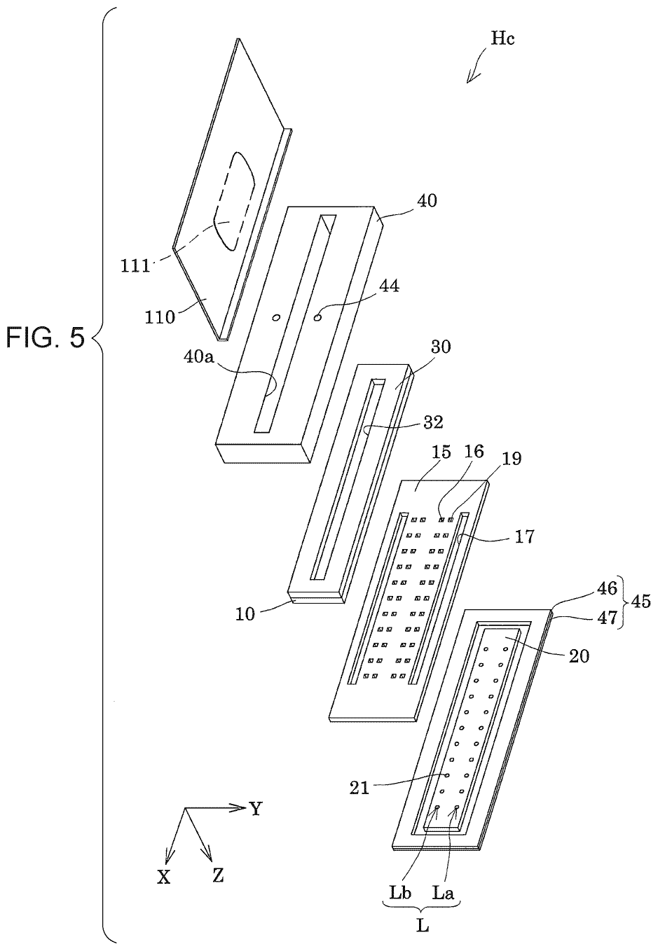

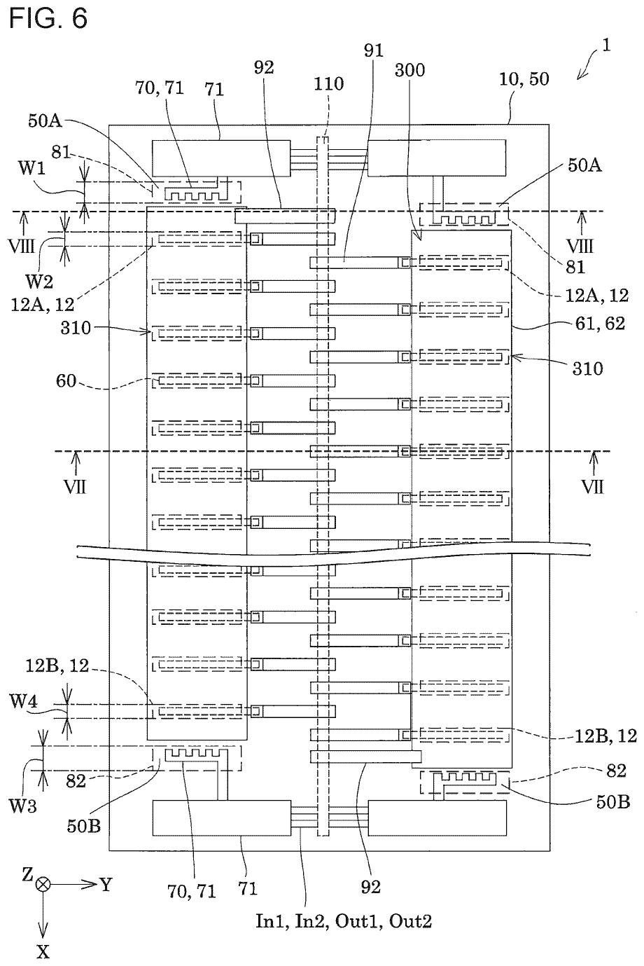

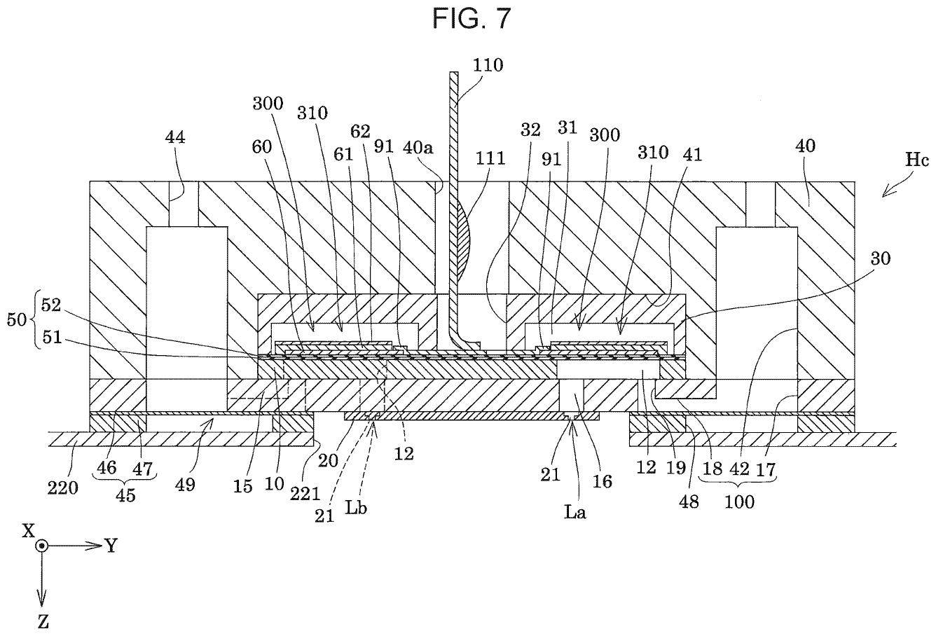

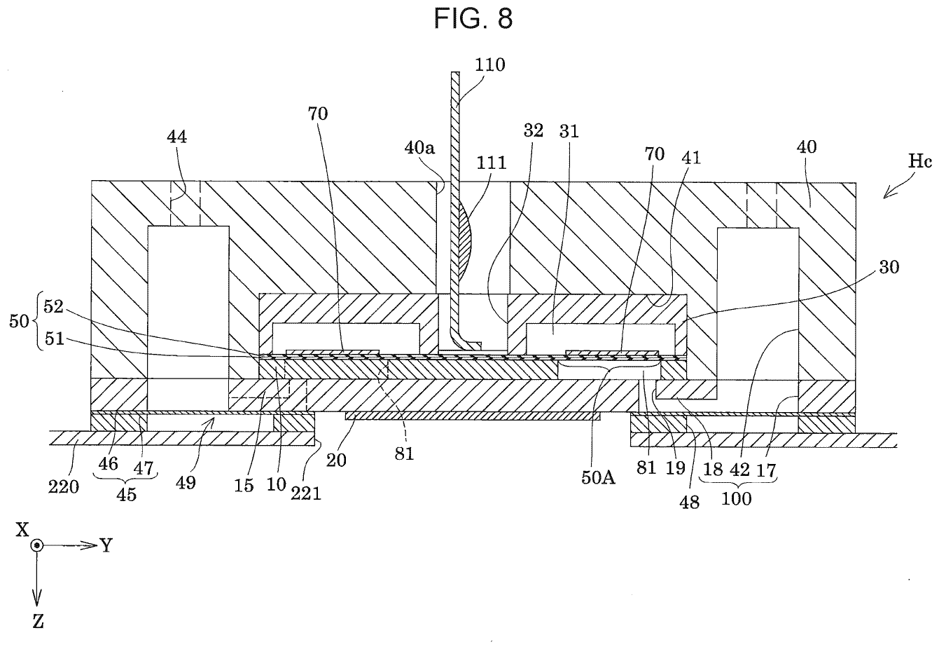

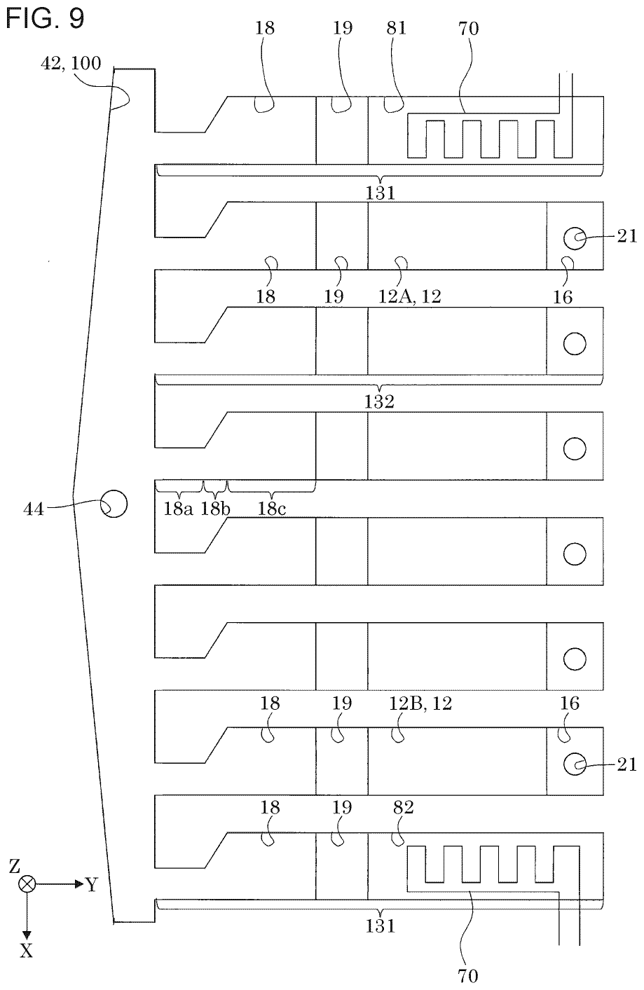

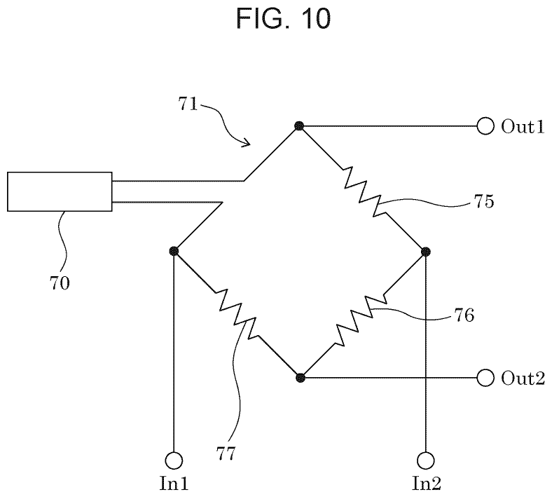

The head chip Hc will be described with reference to FIGS. 5 to 10. FIG. 5 is an exploded perspective view of the head chip Hc. FIG. 6 is a plan view of the head chip Hc. FIG. 7 is a cross-sectional view taken along line VII-VII in FIG. 6. FIG. 8 is a cross-sectional view taken along line VIII-VIII in FIG. 6. FIG. 9 is a plan view showing a flow path of the head chip Hc. FIG. 10 is a diagram showing an example of a strain gauge and a pressure detection section. In FIG. 6, a protective substrate 30, a case member 40, a communication plate 15, and a compliance substrate 45 of the head chip Hc are omitted. Line VII-VII is a line that is parallel to the Y-axis direction and passes through a nozzle 21 that ejects a liquid and a pressure chamber 12 that communicates with the nozzle 21. Line VIII-VIII is a line that is parallel to the Y-axis direction and passes through the strain gauge 70 and the first liquid chamber 81 corresponding to the strain gauge 70. Also, in FIG. 9, for the sake of simplicity, one first individual flow path 131 including the first liquid chamber 81, one first individual flow path 131 including the second liquid chamber 82, and six second individual flow paths 132 including pressure chambers 12 are shown.

The head chip Hc includes one nozzle plate 20 in which a plurality of nozzles 21 are formed, a flow path forming substrate 10, the communication plate 15, the protective substrate 30, the case member 40, the piezoelectric actuator 300, and the wiring member 110.

The flow path forming substrate 10 is made of a silicon substrate or the like, for example. On the flow path forming substrate 10, a plurality of pressure chambers 12 are disposed side by side along the X-axis direction. The plurality of pressure chambers 12 are disposed on a straight line along the X-axis direction such that positions in the Y-axis direction are the same. The two pressure chambers 12 adjacent to each other in the X-axis direction are partitioned by partition walls which are not shown. In addition, in the present embodiment, two rows of pressure chambers 12 in which the pressure chambers 12 are arranged in parallel in the X-axis direction are provided in the Y-axis direction. The two rows of pressure chambers are disposed to be shifted from each other by a so-called half pitch, that is, by half the pitch between the pressure chambers 12 in the X-axis direction. That is, all the pressure chambers 12 in the two rows of pressure chambers are disposed along the X-axis direction in a staggered manner.

Of the plurality of pressure chambers 12, the one located at the end in the −X direction, which is one side in the X-axis direction, is referred to as a first pressure chamber 12A. In the head chip Hc of the present embodiment, there are two rows of pressure chambers 12 arranged in parallel in the X-axis direction, and therefore there are two first pressure chambers 12A. Of the plurality of pressure chambers 12, the one located at the end in the +X direction, which is the other side in the X-axis directions, is referred to as a second pressure chamber 12B. There are also two second pressure chambers 12B, similarly to the first pressure chambers 12A.

The communication plate 15 and the nozzle plate 20 are sequentially stacked on the surface of the flow path forming substrate 10 facing the +Z direction. A vibration plate 50 and the piezoelectric actuator 300 are sequentially stacked on the surface of the flow path forming substrate 10 facing the −Z direction.

The communication plate 15 is formed of a plate-shaped member bonded to the surface of the flow path forming substrate 10 facing the +Z direction. The communication plate 15 is provided with a nozzle communication passage 16 through which the pressure chamber 12 and the nozzle 21 communicate with each other. The communication plate 15 is provided with a first manifold portion 17 and a second manifold portion 18 that form a portion of a manifold 100 serving as a common liquid chamber with which the plurality of pressure chambers 12 commonly communicate. The first manifold portion 17 is provided to penetrate the communication plate 15 in the Z-axis direction. The second manifold portion 18 is provided to open on the surface on the side facing the +Z direction without penetrating the communication plate 15 in the Z-axis direction. Furthermore, the communication plate 15 is provided with a supply communication passage 19 that communicates with the pressure chamber 12 independently in each of the pressure chambers 12. The supply communication passage 19 communicates between the second manifold portion 18 and the pressure chambers 12 to supply the ink in the manifold 100 to the pressure chambers 12. As such a communication plate 15, a silicon substrate, a glass substrate, an SOI substrate, various ceramic substrates, a metal substrate such as a stainless steel substrate, or the like can be used.

The nozzle plate 20 is bonded to the side of the communication plate 15 opposite to the flow path forming substrate 10, that is, to the surface facing the +Z direction. A plurality of nozzles 21 that communicate with the respective pressure chambers 12 via nozzle communication passages 16 are formed in the nozzle plate 20. In the present embodiment, the plurality of nozzles 21 are disposed to be arranged in a row along the X-axis direction. In the present embodiment, two nozzle rows L, in which the nozzles 21 are arranged in parallel along the X-axis direction, are provided at a distance in the Y-axis direction. In the present embodiment, the two nozzle rows L are referred to as a nozzle row La and a nozzle row Lb in the +Y direction in this order. When the nozzle rows La and Lb are not distinguished from each other, the nozzle rows La and Lb are referred to as the nozzle row L below. The nozzle rows La and Lb are disposed to be shifted from each other by a so-called half pitch, that is, by half the pitch between the nozzles 21, in the X-axis direction. That is, all of the nozzles 21 in the nozzle rows La and Lb are disposed in a staggered manner along the X-axis direction.

As such a nozzle plate 20, a silicon substrate, a glass substrate, an SOI substrate, various ceramic substrates, a metal substrate such as a stainless steel substrate, an organic substance such as a polyimide resin, or the like can be used.

In the present embodiment, the vibration plate 50 includes an elastic film 51 that is provided on the flow path forming substrate 10 side and is formed of silicon oxide, and an insulator film 52 that is provided on the surface of the elastic film 51 facing the −Z direction and is formed of zirconium oxide. The vibration plate 50 may be formed of only the elastic film 51 or only the insulator film 52, and may have a configuration in which other films are provided in addition to the elastic film 51 and the insulator film 52.

The piezoelectric actuator 300 includes a first electrode 60, a piezoelectric layer 61, and a second electrode 62 that are sequentially stacked on the vibration plate 50 in the −Z direction. Such a piezoelectric actuator 300 is also called a piezoelectric element, and refers to a portion including the first electrode 60, the piezoelectric layer 61, and the second electrode 62. In addition, a portion where piezoelectric strain occurs in the piezoelectric layer 61 when a voltage is applied between the first electrode 60 and the second electrode 62 is referred to as an active portion 310. That is, the active portion 310 refers to a portion where the piezoelectric layer 61 is interposed between the first electrode 60 and the second electrode 62. In the present embodiment, the active portion 310 is formed for each pressure chamber 12. The plurality of active portions 310 serve as “drive elements” that cause pressure changes in the ink inside the pressure chamber 12. In general, one of the electrodes of the active portion 310 is configured as an independent individual electrode for each active portion 310, and the other electrode is configured as a common electrode common to the plurality of active portions 310. In the present embodiment, the first electrode 60 is separated for each active portion 310 to form an individual electrode of the active portion 310, and the second electrode 62 is continuously provided over the plurality of active portions 310 to form a common electrode for the plurality of active portions 310. The first electrode 60 may form a common electrode, and the second electrode 62 may form an individual electrode.

The piezoelectric layer 61 is configured, for example, using a piezoelectric material made of a perovskite structure composite oxide represented by the general formula ABO₃.

An individual lead electrode 91, which is a lead-out wiring, is drawn out from the first electrode 60. A common lead electrode 92, which is a lead-out wiring, is drawn out from the second electrode 62. The wiring member 110 formed of a flexible substrate having flexibility is coupled to the end portions of the individual lead electrode 91 and the common lead electrode 92 opposite to the end portions thereof coupled to the piezoelectric actuator 300. A drive signal selection circuit 111 is mounted on the wiring member 110. The drive signal selection circuit 111 has a plurality of switching elements for selecting whether or not to supply a drive signal Com for driving each active portion 310 to each active portion 310. In other words, the wiring member 110 in the present embodiment is a chip-on-film (COF). The drive signal selection circuit 111 may not be provided in the wiring member 110. In other words, the wiring member 110 may be a flexible flat cable (FFC), a flexible printed circuit (FPC), and the like.

Further, a protective substrate 30 having substantially the same size as that of the flow path forming substrate 10 is bonded to the surface of the flow path forming substrate 10 facing the −Z direction. The protective substrate 30 has an accommodation portion 31 which is a space for protecting the piezoelectric actuator 300. The accommodation portion 31 is independently provided for each row of the piezoelectric actuators 300 disposed to be arranged in the X-axis direction, and two accommodation portions 31 are formed to be arranged in the Y-axis direction. A through hole 32 penetrating in the Z-axis direction is provided between the two accommodation portions 31 disposed to be arranged in the Y-axis direction, in the protective substrate 30. The end portions of the individual lead electrode 91 and the common lead electrode 92 drawn out from the electrodes of the piezoelectric actuator 300 are extended to be exposed in the through hole 32. The individual lead electrode 91 and the common lead electrode 92 are electrically coupled to the wiring member 110 in the through hole 32. As such a protective substrate 30, for example, a substrate made of a silicon substrate, a glass substrate, an SOI substrate, and various ceramic substrates is used similarly to the flow path forming substrate 10.

A case member 40 that defines the manifold 100 that communicates with the plurality of pressure chambers 12 together with the flow path forming substrate 10 is fixed on the protective substrate 30. The case member 40 has substantially the same shape as the communication plate 15 described above in a plan view, and is bonded to the protective substrate 30 and also bonded to the communication plate 15 described above. Such a case member 40 has a recess portion 41 having a depth for accommodating the flow path forming substrate 10 and the protective substrate 30 on the protective substrate 30 side. The case member 40 is provided with a third manifold portion 42 that communicates with the first manifold portion 17 of the communication plate 15.

The first manifold portion 17 and the second manifold portion 18 provided in the communication plate 15 and the third manifold portion 42 provided in the case member 40 configure the manifold 100 of the present embodiment. The manifold 100 is an example of a first common liquid chamber that is commonly coupled to the plurality of pressure chambers 12 and the first liquid chamber 81 and the second liquid chamber 82, which will be described later. In a plan view of the +Z direction shown in FIG. 9, the manifold 100 is formed such that the width in the Y-axis direction becomes narrower toward the +X direction and the −X direction.

In addition, the manifold 100 is provided for each of the nozzle rows La and Lb, that is, two manifolds in total are provided. Therefore, different liquids can be ejected from the nozzle rows La and Lb. The case member 40 is provided with an inlet 44 that communicates with the manifolds 100 to supply an ink to each of the manifolds 100. In addition, the case member 40 is provided with a coupling port 40a through which the wiring member 110 is inserted to communicate with the through hole 32 of the protective substrate 30. The wiring member 110 flows out to the surface side of the liquid ejecting head 2 facing the −Z direction, via the coupling port 40a. As the case member 40, a metal material, a resin material, or the like can be used.

When viewed in the +Z direction shown in FIG. 9, the inlet 44 is disposed between the first pressure chamber 12A and the second pressure chamber 12B in the X-axis direction. In the present embodiment, the inlet 44 is disposed at the middle of the manifold 100 in the X-axis direction. The middle of the manifold 100 refers to any position of the second portion when the manifold 100 is divided into three equal portions in the X-axis direction, and the first portion, the second portion, and the third portion are arranged from the −X direction to the +X direction.

The compliance substrate 45 is provided on the surface of the communication plate 15 on the +Z direction side where the first manifold portion 17 and the second manifold portion 18 are open. The compliance substrate 45 seals the openings of the first manifold portion 17 and the second manifold portion 18 on the +Z direction side. In the present embodiment, such a compliance substrate 45 includes a sealing film 46 made of a flexible thin film, and a fixed substrate 47 made of a hard material such as metal. Since a region of the fixed substrate 47 facing the manifold 100 is an opening 48 that is completely removed in a thickness direction, one surface of the manifold 100 is a compliance portion 49 which is a flexible portion sealed only by the flexible sealing film 46. A surface of the fixed substrate 47 facing the +Z direction is fixed to a surface of the cover head 220 facing the −Z direction with an adhesive or the like.

In such a head chip Hc, the liquid is taken in from the inlet 44, and the inside of the flow path from the manifold 100 to the nozzle 21 is filled with ink. Thereafter, a voltage is applied to each active portion 310 corresponding to the pressure chamber 12 in accordance with a signal from the drive signal selection circuit 111, and thus the vibration plate 50 is flexurally deformed along with the piezoelectric actuator 300. Accordingly, pressure of the liquid in the pressure chamber 12 increases, and liquid droplets are ejected from a predetermined nozzle 21.

Also, as shown in FIGS. 6, 8, and 9, the head chip Hc has the first liquid chamber 81, the second liquid chamber 82, and the strain gauge 70 provided in each of the first liquid chamber 81 and the second liquid chamber 82.

Specifically, the first liquid chamber 81 and the second liquid chamber 82 are formed in the flow path forming substrate 10, and the first liquid chamber 81 is disposed in the −X direction with respect to the first pressure chamber 12A located at the end of the plurality of pressure chambers 12 in the −X direction. The second liquid chamber 82 is disposed in the +X direction with respect to the second pressure chamber 12B located at the end of the plurality of pressure chambers 12 in the +X direction. In the present embodiment, there are two rows of the plurality of pressure chambers 12 arranged in parallel in the X-axis direction, and therefore, two first liquid chambers 81 and two second liquid chambers 82 are provided.

The first liquid chamber 81 is disposed in the −X direction from the first pressure chamber 12A at an interval equal to the interval between the pressure chambers 12 in the X-axis direction, and is formed such that its shape in a plan view in the +Z direction shown in FIG. 6 is substantially the same as that of the pressure chamber 12. However, the first liquid chambers 81 may not be spaced apart at the same intervals as the pressure chambers 12 in the X-axis direction. Further, the first liquid chamber 81 is coupled to the supply communication passage 19 of the communication plate 15, and the first liquid chamber 81 and the manifold 100 are in communication with each other via the supply communication passage 19.

The second liquid chamber 82 is disposed in the +X direction from the second pressure chamber 12B at an interval equal to the interval between the pressure chambers 12 in the X-axis direction, and is formed such that its shape in a plan view in the +Z direction shown in FIG. 6 is substantially the same as that of the pressure chamber 12. However, the second liquid chamber 82 may not be spaced apart at the same intervals as the pressure chambers 12 in the X-axis direction. The second liquid chamber 82, similarly to the first liquid chamber 81, is in communication with the manifold 100 via the supply communication passage 19. In the present embodiment, the first liquid chamber 81 and the second liquid chamber 82 are not coupled to the nozzle communication passage 16 and are not in communication with the nozzle 21 that ejects the liquid.

In this manner, the first individual flow path 131 and the second individual flow path 132 are formed from the flow paths formed in the flow path forming substrate 10 and the communication plate 15. The first individual flow path 131 refers to a flow path that is coupled to the manifold 100 and includes the first liquid chamber 81. The first individual flow path 131 in the present embodiment includes the second manifold portion 18, the supply communication passage 19, and the first liquid chamber 81. Further, the second liquid chamber 82 located on the opposite side to the first liquid chamber 81 in the X-axis direction also constitutes the first individual flow path. That is, the flow path that is coupled to the manifold 100 and includes the second manifold portion 18, the supply communication passage 19, and the second liquid chamber 82 is also the first individual flow path 131.

The second individual flow paths 132 refer to flow paths that are coupled to the manifold 100, communicate with each of the plurality of nozzles 21, and include each of the plurality of pressure chambers 12. The second individual flow path 132 in the present embodiment includes the second manifold portion 18, the supply communication passage 19, the pressure chamber 12, and the nozzle communication passage 16.

In the present embodiment, in a plan view in the +Z direction as shown in FIG. 9, the width of the first individual flow path 131 in the Y-axis direction is equal to the width of the second individual flow path 132 in the Y-axis direction. Of course, the first individual flow paths 131 and the second individual flow paths 132 may not have the same width in the Y-axis direction.

Further, the first individual flow path 131 and the second individual flow path 132 are both narrowed down at the portions coupled to the manifold 100. Specifically, as shown in FIG. 9, the second manifold portion 18 includes a narrowed portion 18a that is coupled to the manifold 100 and has a constant width in the X-axis direction, a gradually increasing portion 18b whose width in the X-axis direction gradually increases from the narrowed portion 18a toward the supply communication passage 19, and a constant width portion 18c whose width in the X-axis direction is constant from the gradually increasing portion 18b toward the supply communication passage 19. A width of the narrowed portion 18a in the X-axis direction is narrower than a width of the constant width portion 18c in the X-axis direction.

In this manner, each of the first individual flow paths 131 and the second individual flow paths 132 has the narrowed portion 18a in which the width of the flow path in the X-axis direction is narrowed down, but the present disclosure is not limited to this configuration. For example, it is preferable not to provide the narrowed portion 18a in the first individual flow path 131 including the first liquid chamber 81. In other words, it is preferable that the first individual flow path 131 is formed such that the width in the X-axis direction remains constant. Since the width of the first liquid chamber 81 is not narrowed by the narrowed portion 18a, the accuracy of detecting the pressure of the first liquid chamber 81 can be improved.

The first liquid chamber 81 and the second liquid chamber 82 are defined by the vibration plate 50 at the opening on the −Z direction side of a through hole that is formed in the flow path forming substrate 10 and penetrates in the Z-axis direction. That is, the portions of the first liquid chamber 81 and the second liquid chamber 82 are defined by the vibration plate 50. A portion of the vibration plate 50 that defines the surface in the +Z direction, which is a portion of the first liquid chamber 81, is referred to as a first vibration plate 50A. A portion of the vibration plate 50 that defines the surface in the +Z direction, which is a portion of the second liquid chamber 82, is referred to as a second vibration plate 50B.

In the present embodiment, as shown in FIG. 6, a width W1 in the X-axis direction of the first vibration plate 50A is larger than a width W2 in the X-axis direction of the vibration plate 50 that defines the surface in the +Z direction that is a portion of the first pressure chamber 12A. Similarly, a width W3 in the X direction of the second vibration plate 50B is also larger than a width W4 in the X-axis direction of the vibration plate 50 that defines the surface in the +Z direction that is a portion of the second pressure chamber 12B.

Further, the first vibration plate 50A has a rectangular shape when viewed in the +Z direction shown in FIG. 6, but the present disclosure is not limited to this shape. For example, the shape may be a parallelogram shape, a so-called rounded rectangle shape (also referred to as a track shape) in which both end portions in the longitudinal direction are semi-circular shapes based on a rectangular shape, or a polygonal shape. In addition, it is preferable that the aspect ratio of the rectangle inscribed with the first vibration plate 50A is 0.8 to 1.2.

The first vibration plate 50A is provided with the strain gauge 70 on the surface opposite to the first liquid chamber 81 side. The strain gauge 70 is made of a metal, polycrystalline silicon, or semiconductor silicon. Examples of the metal include NiCr, Pt, CuNi, and CrN. In the present embodiment, the strain gauge 70 is formed by repeatedly extending and folding back a metal in the X-axis direction. However, the method of forming the strain gauge 70 is not limited to extending and folding back the metal in the X-axis direction. Note that the strain gauges 70 are provided in correspondence with the first vibration plate 50 A that defines the first liquid chamber 81, but are not provided in correspondence with each pressure chamber 12. The second vibration plate 50B is also provided with the strain gauge 70 on the surface opposite to the second liquid chamber 82 side.

The pressures in the first liquid chamber 81 and the second liquid chamber 82 are detected by utilizing the characteristic that the electrical resistance value of metals, semiconductors, and the like changes when a strain occurs. The pressures in the first liquid chamber 81 and the second liquid chamber 82 refer to the pressures that the liquids filled in the first liquid chamber 81 and the second liquid chamber 82 act on the first vibration plate 50A and the second vibration plate 50B. The pressure can be considered to be the same as the pressure of the meniscus formed in the nozzle 21. When an external force is applied to the strain gauge 70 via the first vibration plate 50A and the second vibration plate 50B in accordance with the pressures in the first liquid chamber 81 and the second liquid chamber 82, a stress corresponding to this external force is applied to the strain gauge 70. As a result, a strain occurs in the strain gauge 70, causing a change in the resistance value. By using this resistance value, the pressures in the first liquid chamber 81 and the second liquid chamber 82 can be detected.

By detecting the pressure of the first liquid chamber 81 using the strain gauge 70 in this way, the pressure of the first liquid chamber 81 can be acquired even when the pressure of the liquid does not change. Examples of times when the pressure of the liquid is not changing include when the liquid is only circulating and not being ejected from the nozzle 21, or when there is no flow in the liquid. However, even when the liquid is not being ejected in this way, the pressure value of the first liquid chamber 81 can be measured. As a method for detecting the pressure of the first liquid chamber 81 without using the strain gauge 70, for example, it is possible to detect the residual vibration that occurs after the liquid is ejected via the piezoelectric actuator 300 and measure the pressure of the liquid based on the signal of that residual vibration. However, with the method, the pressure change in the liquid can be obtained only at the moment when the piezoelectric element is deformed.

Although the strain gauge 70 is formed in the first vibration plate 50A, the present disclosure is not limited to such an aspect. For example, another layer may be stacked on the vibration plate 50, and the strain gauge 70 may be formed above that layer. In other words, the first vibration plate refers to one configured with a layer that functions as a vibration plate, and specifically, may be configured with only the vibration plate 50, may be configured with the vibration plate 50 and the first electrode 60 stacked thereon, may be configured with the piezoelectric layer 61, and may be configured with the second electrode 62. When a strain gauge is provided on the first vibration plate including the first electrode 60, the piezoelectric layer 61, and the second electrode 62, the first vibration plate is electrically insulated.

Furthermore, although the configuration in which only the strain gauge 70 is provided on the first vibration plate 50A has been exemplified, the present disclosure is not limited to such a configuration. For example, the piezoelectric actuator 300 may be formed at a portion of the first vibration plate 50A, and the strain gauge 70 may be provided in the remaining portion.

Further, the vibration plate 50 corresponding to the first pressure chamber 12A and the first vibration plate 50A are not separate but are formed of a single continuous member. Similarly, the second vibration plate 50B is formed of a single continuous member with the vibration plate 50. In this way, the first vibration plate 50A and the second vibration plate 50B are formed of the same member as the vibration plate 50 on which the piezoelectric actuator 300 acts. Accordingly, the first vibration plate 50A and the second vibration plate 50B can be manufactured in the same process as the vibration plate 50 on which the piezoelectric actuator 300 acts, thereby reducing costs. Of course, the first vibration plate 50A and the second vibration plate 50B and the vibration plate 50 on which the piezoelectric actuator 300 acts may be manufactured as separate members. Furthermore, the first vibration plate 50A may be made thinner than the vibration plate 50 on which the piezoelectric actuator 300 acts, or may be made of a material that is more easily deformed. This makes it easier for the first vibration plate 50A to deform, so that the pressure of the first liquid chamber 81 can be detected with higher accuracy.

Specifically, the head chip Hc is provided with the detection circuit 71 that acquires an output voltage based on the resistance value of the strain gauge 70. FIG. 10 shows an example of the detection circuit 71.

The detection circuit 71 has a first resistor element 75, a second resistor element 76, and a third resistor element 77 in addition to the above-described strain gauge 70. The strain gauge 70, the first resistor element 75, the second resistor element 76, and the third resistor element 77 constitute a Wheatstone bridge circuit. One end of the strain gauge 70 is coupled to the first resistor element 75, and the other end is coupled to the third resistor element 77. In addition, the first resistor element 75 is coupled to the second resistor element 76, and the second resistor element 76 is coupled to the third resistor element 77. The detection circuit 71 is coupled to a power supply (not shown) that applies a voltage to points In1 and In2. When a change occurs in the resistance value of the strain gauge 70, a voltage difference occurs between points Out1 and Out2.

In the example of FIG. 10, one detection circuit 71 is configured for one strain gauge 70. As shown in FIG. 6, in the head chip Hc, four strain gauges 70 are provided, and therefore, four detection circuits 71 are also provided. In this way, one detection circuit 71 may be provided for each strain gauge 70, or one detection circuit 71 may be shared by a plurality of strain gauges 70. For example, the strain gauges 70 corresponding to the first vibration plate 50A and the second vibration plate 50B may be coupled to a single detection circuit 71. In this case, the strain gauge 70 only needs to be coupled in place of the second resistor element 76 shown in FIG. 10.

It is preferable that the first resistor element 75 to the third resistor element 77 are provided in the same temperature environment as the strain gauge 70 and in a location where no pressure is applied, and that the resistance values of the strain gauge 70 and the first resistor element 75 to the third resistor element 77 when no pressure is applied are the same. Therefore, it is preferable that the first resistor element 75 to the third resistor element 77 are adjacent to the strain gauge 70 provided in the first liquid chamber 81 in the −X direction, and are provided on the same vibration plate 50 as the strain gauge 70, and in the same pattern as the strain gauge 70. When they are formed in the same pattern on the same vibration plate 50, the difference in manufacturing variation between the first resistor element 75 to the third resistor element 77 and the strain gauge 70 can be reduced.

The point In1, the point In2, the point Out1, and the point Out2 of the detection circuit 71 are electrically coupled to the wiring member 110 (see FIG. 6). The wiring member 110 is provided with the pressure acquisition section 72. The pressure acquisition section 72 realizes the function of acquiring the pressure of the first liquid chamber 81 and the second liquid chamber based on the resistance value of the strain gauge 70, and in the present embodiment, the pressure acquisition section 72 is mounted as an electronic circuit provided in the wiring member 110. The pressure acquisition section 72 acquires an output voltage e of the detection circuit 71 and obtains the strain of the strain gauge 70. The relationship between the output voltage e, the strain, and the pressures in the first liquid chamber 81 and the second liquid chamber 82 is stored in advance in the storage section 121. Therefore, the pressures in the first liquid chamber 81 and the second liquid chamber 82 can be obtained based on the output voltage e which is based on the resistance value.

The liquid ejecting head 2 described above includes a plurality of nozzles 21 that eject a liquid, a plurality of pressure chambers 12 to which a pressure for ejecting the liquid from each of the plurality of nozzles 21 is applied and that are arranged in the X-axis direction, a first liquid chamber 81 disposed in the −X direction with respect to a first pressure chamber 12A located at an end of the plurality of pressure chambers 12 in the −X direction, a first vibration plate 50A that defines a portion of the first liquid chamber 81, a manifold 100 commonly coupled to the plurality of pressure chambers 12 and the first liquid chamber 81, and a strain gauge 70 corresponding to the first vibration plate 50A and for acquiring a pressure within the first liquid chamber 81.

In such a liquid ejecting head 2, when the pressure value of the liquid filling all of the nozzles 21 decreases due to, for example, clogging of the filter 401b, the liquid in the vicinity of the first pressure chamber 12A located at one end in the X-axis direction, which is the direction in which the nozzles 21 are arranged in parallel, has a particularly large pressure loss, and there is a high risk of the meniscus formed in the nozzle 21 being destroyed. This is because, as shown in FIG. 9, the first pressure chamber 12A is farther from the inlet 44 and therefore has a relatively larger pressure loss than the liquid in the vicinity of the other pressure chambers 12. Furthermore, in the present embodiment, the width of the manifold 100 in the Y-axis direction becomes narrower from the inlet 44 in the +X direction and in the −X direction, and therefore the first pressure chamber 12A has a relatively larger pressure loss than the liquid in the vicinity of the other pressure chambers 12.

When the pressure in the vicinity of the first pressure chamber 12A, which is at the end in the −X direction among the plurality of pressure chambers 12, is appropriate, there is no need to measure the pressure in the other pressure chambers 12 because the other pressure chambers 12 have a higher pressure. In other words, in order to prevent the destruction of the meniscus in all of the nozzles 21, it is only necessary to measure the pressure in the vicinity of the first pressure chamber 12A in which the pressure loss is particularly large, and it is not necessary to measure the pressure in the vicinity of the other pressure chambers 12.

As described above, in the liquid ejecting head 2 according to the present embodiment, since it is only necessary to measure the pressure of the first liquid chamber 81 in which the pressure loss is particularly large, the strain gauge 70 is provided in correspondence with the first liquid chamber 81. Accordingly, it is possible to prevent destruction of the meniscus in all of the nozzles 21 without increasing the cost and the size of the liquid ejecting head 2, compared to a configuration in which a strain gauge 70 is provided individually in each pressure chamber 12 to measure the pressure. As a specific method, a threshold value of the pressure value is set within a range smaller than the meniscus withstand pressure, and when the pressure value detected based on the resistance value of the strain gauge 70 exceeds the threshold value, a warning is issued to detect an abnormality or to prompt head replacement or filter replacement, thereby preventing destruction of the meniscus. Accordingly, it is possible to suppress the occurrence of a situation in which normal liquid ejection is not possible due to the destruction of the meniscus, to suppress the occurrence of a situation in which air bubbles enter from the nozzle, and to suppress the occurrence of a situation in which normal ejection is not possible. As another specific method, a threshold value of the pressure value is set within a range greater than the meniscus withstand pressure, and when the detected pressure value exceeds the threshold value, a warning is issued to prompt detection of an abnormality in the self-sealing valve, thereby preventing destruction of the meniscus. In this way, it is possible to suppress the occurrence of a situation in which normal liquid ejection is not possible due to the destruction of the meniscus.

Note that the “−X direction” corresponds to a “first direction”. The “strain gauge 70” corresponds to a “first detection element”. The “manifold 100” corresponds to a “first common liquid chamber”. The “first detection element corresponding to the first vibration plate” refers to the strain gauge 70 provided in contact with the surface of the first vibration plate 50A opposite to the surface that defines the first liquid chamber 81. Further, when viewed in the +Z direction, which is the liquid ejection direction, the strain gauge 70, the first liquid chamber 81, and the first vibration plate 50A overlap each other. In this manner, the first detection element is provided to correspond to the first vibration plate, and is therefore not in contact with the liquid. Therefore, the first detection element is not limited to one having liquid resistance.

For example, the first detection element is not limited to the strain gauge 70, and a piezoelectric element or a capacitance sensor, for example, can be applied. When a piezoelectric element is used as the first detection element, the pressure of the first liquid chamber 81 can be detected as follows.

A piezoelectric element is provided as a first detection element on the first vibration plate 50A. The configuration of the piezoelectric element is similar to that of the piezoelectric actuator 300, and therefore detailed description thereof will be omitted. The capacitance is acquired based on the voltage applied to the piezoelectric element provided on the first vibration plate 50A, and the pressure of the first liquid chamber 81 is detected based on the capacitance.

The capacitance changes depending on the pressure of the first liquid chamber 81. Specifically, when the pressure in the first liquid chamber 81 changes, the first vibration plate 50A deforms in response to the change in pressure. When the first vibration plate 50A is deformed, a stress is applied to the piezoelectric element provided on the first vibration plate 50A. When a stress is applied to the piezoelectric element, the polarization state of the piezoelectric element changes. This change in polarization state appears as a change in dielectric constant of the piezoelectric element, causing a change in capacitance. Therefore, the capacitance changes in response to the change in pressure of the first liquid chamber 81.

Since there is a correlation between the capacitance of the piezoelectric element and the pressure of the first liquid chamber 81, the pressure of the first liquid chamber 81 can be detected based on the capacitance by using the piezoelectric element. The pressure acquisition section 72 acquires the capacitance of the piezoelectric element based on the voltage applied to the piezoelectric element, and acquires the pressure of the first liquid chamber 81 based on the capacitance. In this manner, the pressure of the first liquid chamber 81 can be detected based on the capacitance by the pressure acquisition section 72 and the piezoelectric element as the first detection element.

When a capacitance sensor is used as the first detection element, the pressure of the first liquid chamber 81 can be detected as follows. A capacitance sensor is provided as a first detection element corresponding to the first vibration plate 50A. The capacitance sensor has a movable electrode and a fixed electrode. The movable electrode is provided on the surface of the first vibration plate 50A opposite to the second liquid chamber 82 side, and the fixed electrode is provided on the surface in the +Z direction of the protective substrate 30 at a position facing the movable electrode. The first vibration plate 50A deforms in response to the pressure of the first liquid chamber 81, and the position of the movable electrode changes in accordance with the deformation of the first vibration plate 50A. On the other hand, since the position of the fixed electrode does not change, the distance in the Z-axis direction between the movable electrode and the fixed electrode changes depending on the pressure of the first liquid chamber 81. Then, as the distance between the movable electrode and the fixed electrode changes, the capacitance between the movable electrode and the fixed electrode changes. Therefore, the capacitance changes in response to the change in pressure of the first liquid chamber 81. Therefore, in the same manner as in the case of a piezoelectric element, the pressure of the first liquid chamber 81 can be detected based on the capacitance obtained by the capacitance sensor.

The liquid ejecting head 2 according to the present embodiment has a pressure acquisition section 72 that acquires the pressure of the first liquid chamber 81 based on the resistance value of the strain gauge 70.

The liquid ejecting head 2 according to the present embodiment further has an inlet 44 for introducing a liquid into the manifold 100, and the plurality of pressure chambers 12 have a second pressure chamber 12B located at the end in the +X direction, which is the opposite direction to the −X direction, and when viewed in the +Z direction in which the plurality of nozzles 21 eject the liquid, the inlet 44 is disposed between the first pressure chamber 12A and the second pressure chamber 12B in the −X direction. In such a liquid ejecting head 2, compared to when the inlet 44 is disposed outside the pressure chamber 12 in the X-axis direction, neither the first pressure chamber 12A nor the second pressure chamber 12B is significantly farther from the inlet 44 than the other pressure chamber. In other words, the pressure loss in the first pressure chamber 12A and the second pressure chamber 12B at both ends is approximately the same, and it is possible to eliminate any pressure chamber 12 with a significantly large pressure loss. Note that the “+X direction” corresponds to a “second direction”. The “+Z direction” corresponds to an “ejection direction”.

The liquid ejecting head 2 according to the present embodiment further includes a second liquid chamber 82 that is disposed in the +X direction with respect to a second pressure chamber 12B that is located at the end of the plurality of pressure chambers 12 in the +X direction, which is the opposite direction to the −X direction, and that is coupled to the manifold 100, a second vibration plate 50B that defines a portion of the second liquid chamber 82, and a strain gauge 70 corresponding to the second vibration plate 50B and acquiring the pressure within the second liquid chamber 82. The liquid ejecting head 2 as described above can detect the pressures in the first liquid chamber 81 and the second liquid chamber 82. For example, when one detection circuit 71 is provided for a strain gauge 70 as shown in FIG. 10, abnormalities in the meniscus in the nozzles 21 at both ends can be detected individually. In addition, when the strain gauge 70 corresponding to the first vibration plate 50A and the strain gauge 70 corresponding to the second vibration plate 50B are coupled to a common detection circuit 71, the average of the pressure values of the nozzles 21 at both ends can be detected. Note that the “strain gauge 70 corresponding to the second vibration plate 50B and for acquiring the pressure within the second liquid chamber 82” corresponds to a “second detection element”.

The liquid ejecting head 2 according to the present embodiment does not have a piezoelectric actuator 300 corresponding to the first liquid chamber 81, but has a plurality of piezoelectric actuators 300 that apply a pressure to the plurality of pressure chambers 12. That is, only the strain gauge 70 is provided in the first liquid chamber 81, and the piezoelectric actuator 300 is not provided. According to such a liquid ejecting head 2, the first vibration plate 50A is not interfered by the piezoelectric actuator 300, and therefore can be easily deformed. Since the first vibration plate 50A is easily deformed by the pressure of the liquid, the pressure of the first liquid chamber 81 can be detected with higher accuracy.

In the liquid ejecting head 2 according to the present embodiment, the width W1 in the −X direction of the first vibration plate 50A is larger than the width W2 in the −X direction of the vibration plate 50 that defines a portion of the first pressure chamber 12A.

The liquid ejecting head 2 according to the present embodiment has a plurality of individual flow paths coupled to the manifold 100, and the plurality of individual flow paths communicate with each of the plurality of nozzles 21, and have a plurality of second individual flow paths 132 including each of the plurality of pressure chambers 12, and a first individual flow path 131 including a first liquid chamber 81, and the width of the first individual flow path 131 in the Y-axis direction intersecting the −X direction and the +Z direction, which is the ejection direction in which a liquid is ejected, is equal to the width of the second individual flow path 132 in the Y-axis direction. Note that the “Y-axis direction” corresponds to a “third direction”. In addition, in the present embodiment, the widths of the first individual flow paths 131 and the second individual flow paths 132 in the Y-axis direction are set to be equal to each other, but they may be different from each other.

### First Modification Example of First Embodiment

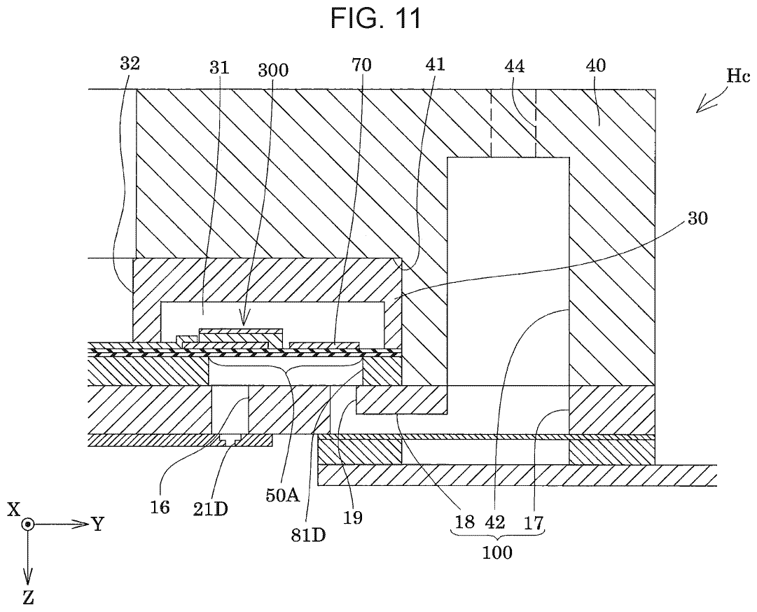

A first modification example of the first embodiment is shown with reference to FIG. 11. A liquid ejecting head 2 according to the first modification example differs from the liquid ejecting head 2 according to the first embodiment in that the first liquid chamber 81 is in communication with a dummy nozzle 21D, and in that a piezoelectric actuator 300 is formed in the first vibration plate 50A in addition to the strain gauge 70. In the first modification example, the first liquid chamber 81 is referred to as a first dummy liquid chamber 81D.

Specifically, in the first dummy liquid chamber 81D, a strain gauge 70 is provided in a portion of the first vibration plate 50A that defines the first dummy liquid chamber 81D, and a piezoelectric actuator 300 is formed in the remaining portion. The strain gauge 70 is not limited to the configuration provided on the first vibration plate 50A, and may be stacked in the +Z direction of the piezoelectric actuator 300, for example.

In addition, the first dummy liquid chamber 81D is in communication with the nozzle communication passage 16 formed in the communication plate 15, similarly to the pressure chamber 12 shown in FIG. 7. The nozzle communication passage 16 is in communication with the dummy nozzle 21D formed in the nozzle plate 20. The dummy nozzle 21D is a nozzle that does not contribute to printing. “Not contributing to printing” means that the liquid is ejected as a flushing to prevent thickening, but liquid droplets for directly forming an image on the medium are not ejected.

The liquid ejecting head 2 according to the first modification example has the same effects as those of the first embodiment. Furthermore, since the first dummy liquid chamber 81D is in communication with the dummy nozzle 21D that does not contribute to printing, a liquid is easily filled into the flow path leading from the manifold 100 to the supply communication passage 19, the first dummy liquid chamber 81D, the nozzle communication passage 16, and the dummy nozzle 21D. Since the flow path can be filled with a liquid well as described above, for example, when an initial filling process is carried out to fill the flow path with a liquid in a state where the first dummy liquid chamber 81D is not filled with a liquid, the first dummy liquid chamber and the dummy nozzle 21D can be filled with a liquid well without leaving any air bubbles or the like.

In the liquid ejecting head 2 having the first dummy liquid chamber 81D, it is preferable to employ a first individual flow path 131 having a narrowed portion 18a as shown in FIG. 9. This is because the above-described flushing can be carried out suitably.

In the first embodiment, the nozzles 21 that do not contribute to printing are not in communication with the first liquid chamber 81, but it is preferable to provide a dummy nozzle 21D as in the first modification example, and provide a piezoelectric actuator 300 in the first dummy liquid chamber 81D. It is desirable to periodically perform cleaning and flushing on the dummy nozzle 21D in the same manner as the other nozzles 21. Accordingly, it is possible to prevent the liquid in the first dummy liquid chamber 81D from becoming thicker.

### Second Modification Example of First Embodiment

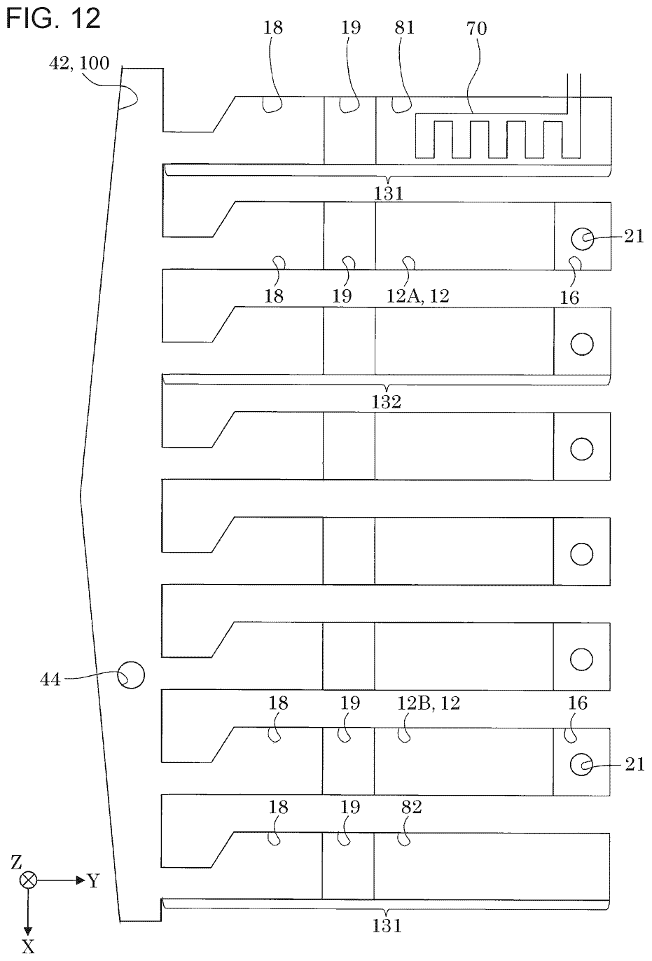

A second modification example of the first embodiment is shown with reference to FIG. 12. A liquid ejecting head 2 according to the second modification example differs from the liquid ejecting head 2 according to the first embodiment in that one strain gauge 70 is provided on one end side in the X-axis direction, and the position of the inlet 44 is different.

Specifically, the strain gauge 70 is provided in correspondence with the first vibration plate 50A (see FIG. 6) that defines the first liquid chamber 81. Also, the distance from the inlet 44 to the first pressure chamber 12A is greater than the distance from the inlet 44 to the second pressure chamber 12B. The distance from the inlet 44 to the first pressure chamber 12A refers to the shortest distance of the flow path leading from the inlet 44 to the first pressure chamber 12A. The same applies to the distance from the inlet 44 to the second pressure chamber 12B.

When the strain gauge 70 is provided at one location as in the liquid ejecting head 2 according to the second modification example, the strain gauge 70 is provided in the first liquid chamber 81 located at the end farthest from the inlet 44. Since the pressure loss increases with increasing distance from the inlet 44, it is possible to detect the pressure of the first liquid chamber 81, which is located at a position where the pressure loss is larger. Furthermore, since only one strain gauge 70 is used, the cost of the liquid ejecting head 2 can be reduced and the size can be made smaller than in a configuration in which a strain gauge 70 is provided at each of both ends in the X-axis direction.

In FIG. 12, the inlet 44 is disposed on the inside of the plurality of pressure chambers 12 in the X-axis direction. In other words, the position of the inlet 44 in the X-axis direction is on the +X direction side of the first pressure chamber 12A at the end in the −X direction, and is on the −X direction side of the second pressure chamber 12B at the end in the +X direction. The disposition of the inlet 44 is not limited thereto, and the inlet 44 may be disposed outside the plurality of pressure chambers 12 in the X-axis direction. In other words, the position of the inlet 44 in the X-axis direction may be disposed on the −X direction side of the first pressure chamber 12A, or disposed on the +X direction side of the second pressure chamber 12B.

### Third Modification Example of First Embodiment

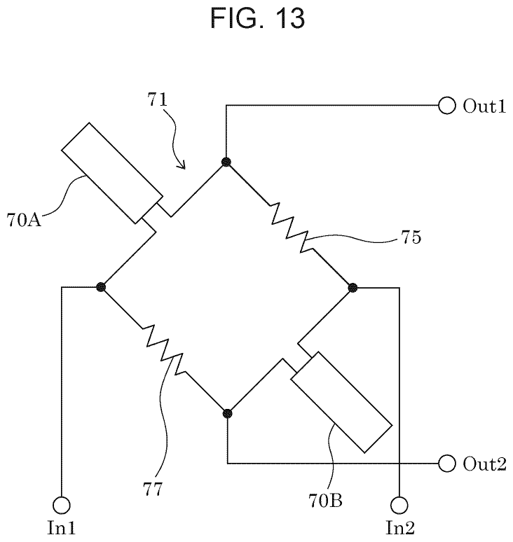

A third modification example of the first embodiment is shown with reference to FIG. 13. A liquid ejecting head 2 according to the third modification example differs from the liquid ejecting head 2 according to the first embodiment in that two strain gauges 70 are provided on the first vibration plate 50A, and the two strain gauges 70 are coupled to one detection circuit 71.

Specifically, the liquid ejecting head 2 corresponds to the first vibration plate 50A (see FIG. 6), and has a strain gauge 70A and a strain gauge 70B for acquiring the pressure inside the first liquid chamber 81 (see FIG. 6). When the strain gauge 70A and the strain gauge 70B show the same resistance change, that is, when the strain gauge 70A and the strain gauge 70B are both disposed in a position where they are tensioned or compressed, the detection circuit 71 has the strain gauge 70A coupled to the first resistor element 75 and the third resistor element 77, and the strain gauge 70B coupled to the first resistor element 75 and the third resistor element 77 instead of the second resistor element 76. The strain gauge 70A, the strain gauge 70B, the first resistor element 75, and the third resistor element 77 constitute a Wheatstone bridge circuit. In addition, when the strain gauge 70A and the strain gauge 70B show different resistance changes, that is, when one of the strain gauge 70A and the strain gauge 70B is tensioned and the other is compressed, the strain gauge 70B and the first resistor element 75 are replaced. That is, the strain gauge 70A is coupled to the third resistor element 77 and the strain gauge 70B, and the strain gauge 70B is coupled to the first resistor element 75 and the strain gauge 70A.

As in the liquid ejecting head 2 according to the third modification example, one detection circuit 71 has two strain gauges 70 provided on one first vibration plate 50A. The pressure acquisition section 72, which acquires the pressure of the first liquid chamber 81 based on the resistance value obtained by the detection circuit 71 having two such strain gauges 70, has improved detection accuracy for the pressure of the first liquid chamber 81 compared to the pressure acquisition section 72, which acquires the pressure of the first liquid chamber 81 based on the resistance value of the detection circuit 71 having one strain gauge 70. Note that the “strain gauge 70A” corresponds to the “first detection element”, and the “strain gauge 70B” corresponds to the “second detection element”.

Although not particularly shown, four strain gauges 70 may be provided on the first vibration plate 50A. Then, the first resistor element 75 and the third resistor element 77 shown in FIG. 13 are each replaced with a strain gauge 70. That is, a Wheatstone bridge circuit may be formed by four strain gauges 70 and the Wheatstone bridge circuit may be used as the detection circuit 71. By configuring the detection circuit 71 in this manner by providing the four strain gauges 70 on the first vibration plate 50A, the pressure of the first liquid chamber 81 can be detected with even greater accuracy.

### Fourth Modification Example of First Embodiment

In the first embodiment, as shown in FIG. 7, two nozzle rows including a nozzle row La and a nozzle row Lb, which are arranged in parallel in the X-axis direction, are provided in the head chip Hc, and two manifolds 100 are provided corresponding to the nozzle rows. As shown in FIG. 6, a total of four strain gauges 70 are provided on the −X direction side of the first pressure chambers 12A corresponding to each of the nozzle row La and the nozzle row Lb, and on the +X direction side of the second pressure chambers 12B.

In a fourth modification example, although not particularly shown, the strain gauges 70 are disposed point-symmetrically in a plan view in the +Z direction as shown in FIG. 6. For example, the strain gauge 70 is provided on the first vibration plate 50A that defines the first liquid chamber 81 located on the −X direction side of the first pressure chamber 12A on the −Y direction side. The strain gauge 70 is provided on the second vibration plate 50B that defines the second liquid chamber 82 located on the +X direction side of the second pressure chamber 12B on the +Y direction side.

In a liquid ejecting head 2 according to the fourth modification example, since the strain gauge 70 is not provided on the first vibration plate 50A on the +Y direction side and the second vibration plate 50B on the −Y direction side, wiring drawn out from the strain gauge 70 can be disposed in these spaces, making it easier to dispose the wiring. Therefore, compared to when four strain gauges 70 are disposed as in FIG. 6, the size of the liquid ejecting head 2 can be made smaller. Furthermore, when the liquid ejecting head 2 is in a posture in which the liquid is ejected in a direction other than the +Z direction, for example, in a posture for vertical printing, a pressure difference occurs between the first liquid chamber 81 and the second liquid chamber 82. This pressure difference can be obtained from the difference between pressure values detected by two strain gauges 70 disposed on the +X direction side and the −X direction side, respectively. Since this pressure difference has a value according to the angle between the direction in which the liquid ejecting head 2 ejects a liquid and the horizontal plane, the angle (posture) of the liquid ejecting head 2 can be detected based on the pressure difference.

### Fifth Modification Example of First Embodiment

In the fourth modification example, two strain gauges 70 are provided to be point-symmetric when viewed in the +Z direction shown in FIG. 6, but in a fifth modification example, the strain gauges 70 are disposed to be symmetrical in the X-axis direction, which is the arrangement direction of the pressure chambers 12.

Specifically, although not particularly shown, the strain gauge 70 is provided on the first vibration plate 50A that defines the first liquid chamber 81 located on the −X direction side of the first pressure chamber 12A on the −Y direction side. The strain gauge 70 is provided on the first vibration plate 50A that defines the first liquid chamber 81 located on the −X direction side of the first pressure chamber 12A on the +Y direction side. According to a liquid ejecting head 2 according to the fifth modification example, since the strain gauge 70 is not provided on the second vibration plate 50B that defines the second liquid chamber 82, the size of the head chip Hc in the X-axis direction can be made smaller.

### Sixth Modification Example of First Embodiment

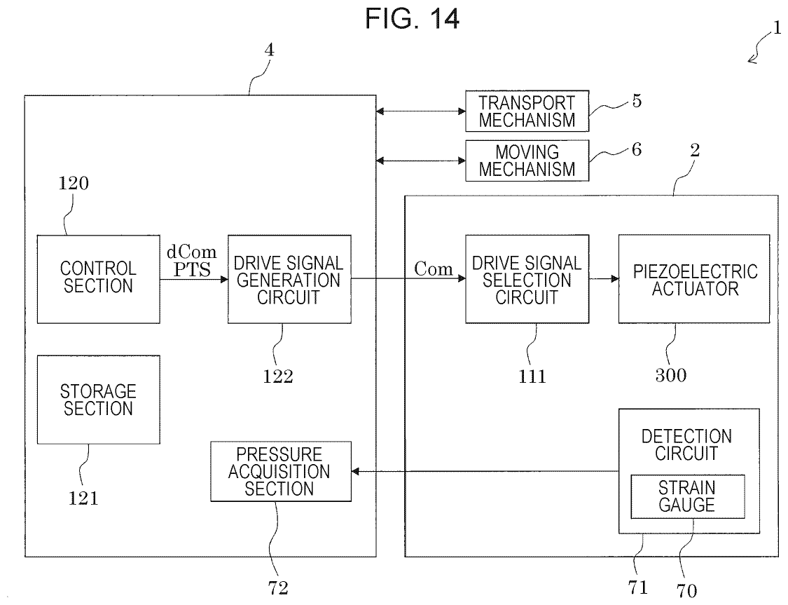

In the first embodiment, the pressure acquisition section 72 is provided on the wiring member 110 of the liquid ejecting head 2, but the present disclosure is not limited to such a configuration. FIG. 14 is a block diagram of a liquid ejecting apparatus 1 according to a sixth modification example. The liquid ejecting apparatus 1 according to the sixth modification example has a liquid ejecting head 2 and a pressure acquisition section 72. The pressure acquisition section 72 is provided in the liquid ejecting apparatus 1 instead of in the liquid ejecting head 2. For example, a pressure acquisition section 72 is provided as a portion of the control unit 4 of the liquid ejecting apparatus 1. In this case, the head chip Hc has a strain gauge 70 and a detection circuit 71, and an output voltage e detected by the detection circuit 71 is transmitted to the pressure acquisition section 72 of the control unit 4 via a wiring member 110, a relay substrate 210, or the like. Even with this configuration, the same effects as those of the liquid ejecting apparatus 1 including the liquid ejecting head 2 according to the first embodiment can be achieved.

### Second Embodiment

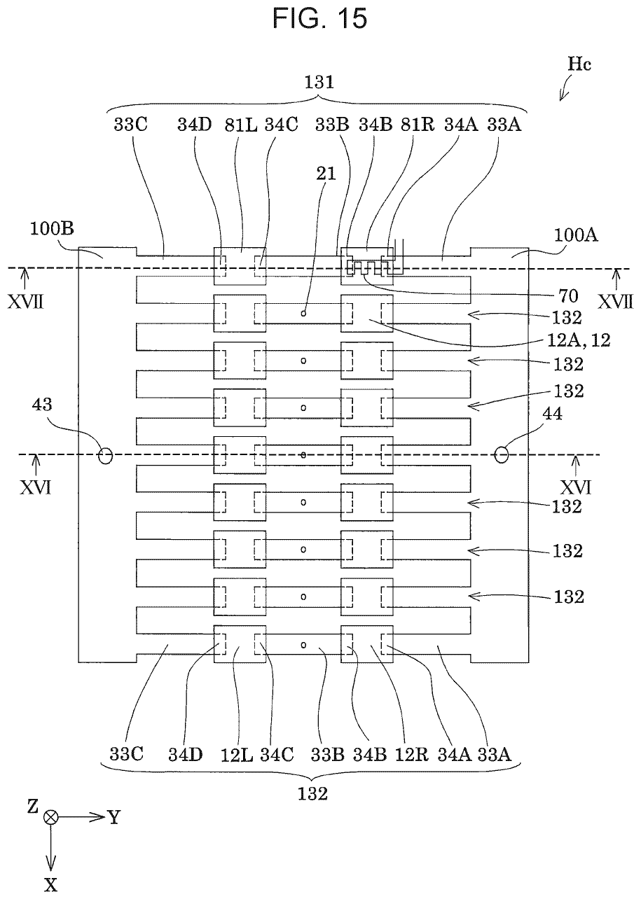

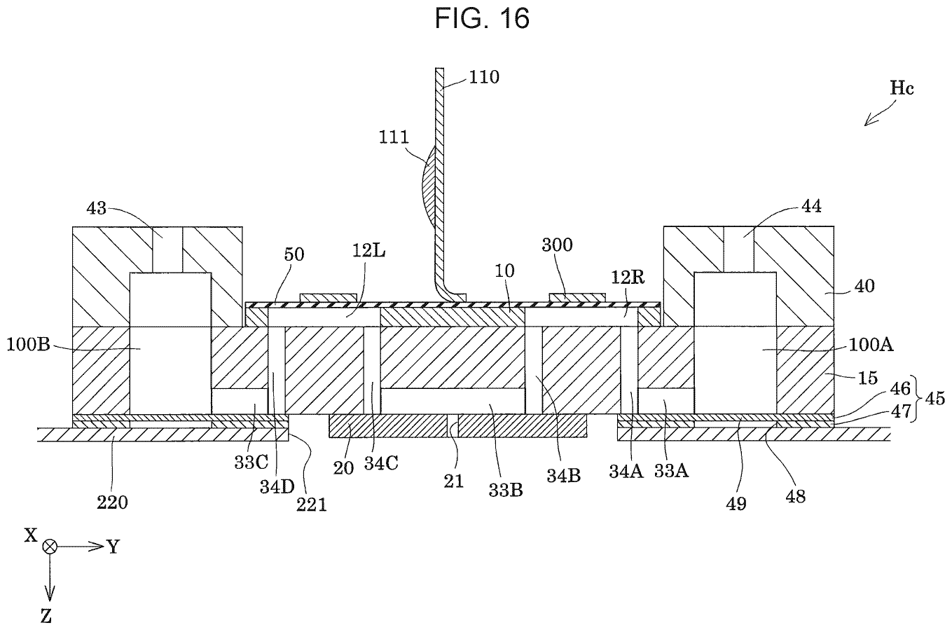

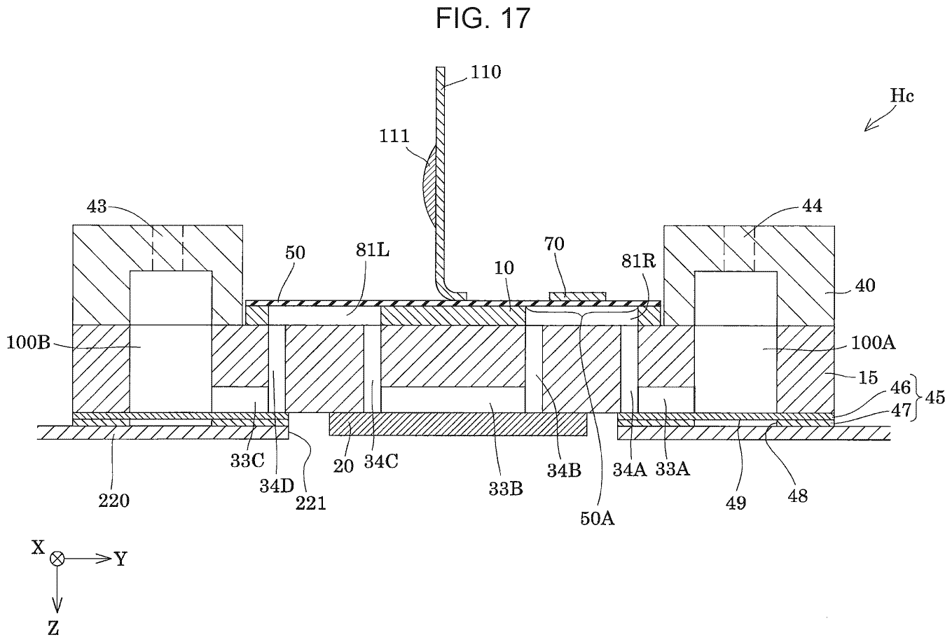

The present disclosure can also be applied to a so-called circulation type liquid ejecting head 2. FIG. 15 is a plan view showing a flow path of a head chip according to a second embodiment. FIG. 16 is a cross-sectional view taken along line XVI-XVI in FIG. 15. FIG. 17 is a cross-sectional view taken along line XVII-XVII in FIG. 15. In FIG. 15, a vibration plate 50 and a piezoelectric actuator 300 are omitted. The same components as those in the first embodiment are designated by the same reference numerals, and the duplicated descriptions will be omitted.

A head chip Hc includes a first individual flow path 131 and a second individual flow path 132. In the present embodiment, when viewed in the +Z direction shown in FIG. 15, the first individual flow path 131 and the second individual flow path 132 extend in the Y-axis direction and are disposed at an interval in the X-axis direction.

The head chip Hc includes a supply manifold 100A for supplying a liquid to a plurality of nozzles 21 and a recovery manifold 100B for recovering the liquid that is not ejected from the plurality of nozzles 21.

The head chip Hc is provided with an inlet 44 that communicates with the supply manifold 100A and an outlet 43 that communicates with the recovery manifold 100B. The liquid is introduced into the inlet 44 from a liquid storage portion 3 provided in the liquid ejecting apparatus 1. The outlet 43 is coupled to the liquid storage portion 3 such that the liquid is recovered from the outlet 43 to the liquid storage portion 3.

A liquid is supplied from the inlet 44 to the supply manifold 100A of the head chip Hc. The liquid in the supply manifold 100A is supplied to the first individual flow path 131 and the second individual flow path 132, and the liquid supplied to the second individual flow path 132 is ejected from each nozzle 21. Of the liquid supplied to the second individual flow path 132, the liquid that is not ejected from the nozzles 21 is discharged to the recovery manifold 100B. On the other hand, the first individual flow path 131 is not provided with the nozzle 21. Therefore, the liquid flows through the supply manifold 100A, the first individual flow path 131, and the recovery manifold 100B in this order.

The configuration of the head chip Hc will be described in more detail. A flow path forming substrate 10 is provided with a plurality of pressure chambers 12R and 12L corresponding to the respective nozzles 21. The pressure chamber 12R and the pressure chamber 12L are provided to penetrate the flow path forming substrate 10 in the Z direction, which is a thickness direction. In the present embodiment, one second individual flow path 132 includes one pressure chamber 12R and one pressure chamber 12L. The pressure chamber 12R is disposed closer to the supply manifold 100A, and the pressure chamber 12L is disposed closer to the recovery manifold 100B.

The vibration plate 50 and the piezoelectric actuator 300 are formed at the −Z direction side of the flow path forming substrate 10. The piezoelectric actuator 300 is provided at a position on the vibration plate 50 corresponding to the pressure chamber 12R and the pressure chamber 12L.

A communication plate 15 is provided with a first communication flow path 33A, a first communication flow path 33B, a first communication flow path 33C, a second communication flow path 34A, a second communication flow path 34B, a second communication flow path 34C, and a second communication flow path 34D as the flow paths constituting the second individual flow path 132.

The first communication flow path 33A opens on the +Z direction side of the communication plate 15, extends in the Y-axis direction, and has one end portion that communicates with the supply manifold 100A.

The first communication flow path 33B opens on the +Z direction side of the communication plate 15, extends in the Y-axis direction, and communicates with the nozzle 21.

The first communication flow path 33C opens on the +Z direction side of the communication plate 15, extends in the Y-axis direction, and has one end portion that communicates with the recovery manifold 100B.

The second communication flow path 34A penetrates the communication plate 15 in the Z-axis direction, and communicates between the first communication flow path 33A and the pressure chamber 12R.

The second communication flow path 34B penetrates the communication plate 15 in the Z-axis direction, and communicates between the pressure chamber 12R and the first communication flow path 33B.

The second communication flow path 34C penetrates the communication plate 15 in the Z-axis direction, and communicates between the first communication flow path 33B and the pressure chamber 12L.

The second communication flow path 34D penetrates the communication plate 15 in the Z-axis direction, and communicates between the pressure chamber 12L and the first communication flow path 33C.

The openings on the +Z direction side of the first communication flow path 33A, the first communication flow path 33B, the first communication flow path 33C, the second communication flow path 34A, the second communication flow path 34B, the second communication flow path 34C, and the second communication flow path 34D are sealed by a compliance substrate 45 to form a flow path. In this manner, the second individual flow path 132 in the present embodiment is composed of the first communication flow path 33A, the second communication flow path 34A, the pressure chamber 12R, the second communication flow path 34B, the first communication flow path 33B, the second communication flow path 34C, the pressure chamber 12L, the second communication flow path 34D, and the first communication flow path 33C.

On the other hand, the first individual flow path 131 has a configuration similar to that of the second individual flow path 132, but differs from the second individual flow path 132 in that the first individual flow path 131 is not in communication with the nozzle 21. In addition, the first individual flow path 131 differs from the second individual flow path 132 in that the first individual flow path 131 has a first liquid chamber 81R and a first liquid chamber 81L instead of the pressure chamber 12R and the pressure chamber 12L. That is, the first individual flow path 131 in the present embodiment is composed of the first communication flow path 33A, the second communication flow path 34A, the first liquid chamber 81, the second communication flow path 34B, the first communication flow path 33B, the second communication flow path 34C, the first liquid chamber 81L, the second communication flow path 34D, and the first communication flow path 33C.

The strain gauge 70 is provided in correspondence with the first vibration plate 50A that defines the first liquid chamber 81R. In the present embodiment, the strain gauge 70 is not provided in the first liquid chamber 81L, but the strain gauge 70 may be provided in correspondence with the first liquid chamber 81L. In addition, although not particularly shown, a detection circuit is provided on the vibration plate 50, and it is possible to detect the pressure of the first liquid chamber 81L in the same manner as in the first embodiment.

The liquid ejecting head 2 according to the second embodiment described above includes a plurality of second individual flow paths 132 to which a liquid is supplied from the supply manifold 100A, the plurality of second individual flow paths 132 that communicate with each of the plurality of nozzles 21 and including each of the plurality of pressure chambers 12, a recovery manifold 100B for recovering the liquid that is not ejected from the plurality of nozzles 21 from the plurality of second individual flow paths 132, and a first individual flow path 131 that includes a first liquid chamber 81R and couples the supply manifold 100A and the recovery manifold 100B.

In such a liquid ejecting head 2, the pressure in the plurality of pressure chambers 12 does not vary significantly whether the pressure chambers 12 are located at the end portions in the X-axis direction or the pressure chambers 12 are located at the center portion. Therefore, in order to prevent the destruction of the meniscus in all of the nozzles 21, it can be said that the pressure may be measured in the vicinity of any pressure chamber 12. Therefore, in the liquid ejecting head 2 according to the present embodiment, the strain gauge 70 is provided only on the first vibration plate 50A that defines the first liquid chamber 81R to measure only the pressure of the first liquid chamber 81R. Accordingly, it is possible to suppress increases in cost and size of the liquid ejecting head 2 compared to a configuration in which a strain gauge 70 is provided to measure the pressure in each of the pressure chambers 12, and to prevent destruction of the meniscus in all of the nozzles 21.

Among the plurality of pressure chambers 12 arranged in parallel in the X-axis direction, a first liquid chamber 81R is provided on the −X direction side of a first pressure chamber 12A located at the end portion in the −X direction, and a strain gauge 70 is provided in the first liquid chamber 81R. Accordingly, the nozzles 21 that contribute to printing can be disposed at equal intervals and with a higher density compared to when the first liquid chamber 81R is provided at a place other than the end portion, such as when the first liquid chamber 81R is provided between adjacent first pressure chambers 12A in the X-axis direction, for example.

Furthermore, in the liquid ejecting head 2 according to the present embodiment, since the liquid circulates, thickening of the liquid in the first liquid chamber 81R is prevented, and the pressure can be detected accurately.

Note that the “supply manifold 100A” corresponds to the “first common liquid chamber”, and the “recovery manifold 100B” corresponds to the “second common liquid chamber”. Further, the first individual flow path 131 is not provided with the nozzle 21, but a dummy nozzle may be provided in the same manner as in the first modification example of the first embodiment.

### Other Embodiments

Although each embodiment of the present disclosure has been described above, the basic configuration of the present disclosure is not limited to the above embodiments.

Moreover, in each of the above-described embodiments, a thin-film type piezoelectric actuator 300, which is essentially the active portion 310, was used as the drive element for generating a pressure change in the pressure chamber 12, but the present disclosure is not particularly limited thereto, and as the drive element, for example, a thick-film type piezoelectric actuator formed by a method such as adhering a green sheet, a longitudinal vibration type piezoelectric actuator in which piezoelectric material and electrode forming material are alternately stacked to expand and contract in the axial direction, or the like can be used. In addition, as the drive element, for example, an element in which a heating element is disposed in the pressure chamber 12 to eject the liquid droplets from the nozzle 21 by bubbles generated due to the heat of the heating element, or a so-called electrostatic actuator that generates static electricity between a vibration plate and an electrode, deforms the vibration plate by the electrostatic force, and ejects the liquid droplets from the nozzle 21 can be used.

In addition, the above-mentioned liquid ejecting apparatus 1 has been exemplified as one in which the liquid ejecting head 2 moves in a main scanning direction, which is the Y-axis direction, but the present disclosure is not particularly limited thereto, and the present disclosure can also be applied to, for example, a so-called line printer in which the liquid ejecting head 2 is fixed and printing is performed simply by moving the medium S in a sub-scanning direction, which is the X-axis direction.

Further, the present disclosure is intended to cover a wide range of liquid ejecting apparatuses equipped with ejecting sections. Examples of the ejecting section include recording heads such as various ink jet recording heads used in an image recording apparatus such as a printer, and coloring material ejecting heads used in the manufacture of color filters in liquid crystal displays and the like. Examples of the ejecting section include an electrode material ejecting head used for forming an electrode in an organic EL display, a field emission display (FED), and the like, and a bioorganic substance ejecting head used for manufacturing a biochip. The present disclosure can also be applied to liquid ejecting apparatuses equipped with these ejecting sections.

### Supplementary Notes

From the above-mentioned exemplary embodiments, the following configurations can be understood, for example.

According to Aspect 1 which is a preferred aspect, there is provided a liquid ejecting head including: a plurality of nozzles that eject a liquid; a plurality of pressure chambers to which a pressure for ejecting the liquid from each of the plurality of nozzles is applied and that are arranged in a first direction; a first liquid chamber disposed in the first direction with respect to a first pressure chamber located at an end of the plurality of pressure chambers in the first direction; a first vibration plate that defines a portion of the first liquid chamber; a first common liquid chamber commonly coupled to the plurality of pressure chambers and the first liquid chamber; and a first detection element for acquiring a pressure within the first liquid chamber, the first detection element corresponding to the first vibration plate. According to this, it is possible to prevent destruction of the meniscus in all nozzles without increasing the cost and the size of the liquid ejecting head, compared to a configuration in which a first detection element is provided individually in each pressure chamber to measure the pressure. Specifically, when the pressure value detected based on the resistance value of the first detection element exceeds a threshold value of the pressure value set within a range smaller than the meniscus withstand pressure before the meniscus is destroyed, an abnormality is detected or a warning is issued prompting replacement of the liquid ejecting head or replacement of a filter, or the like. Accordingly, the quality of the liquid ejecting head is improved. Specifically, it is possible to suppress the occurrence of a situation in which normal liquid ejection is not possible due to the destruction of the meniscus, to suppress the occurrence of a situation in which air bubbles enter from the nozzle, and to suppress the occurrence of a situation in which normal ejection is not possible.

In Aspect 2 which is a specific example of the Aspect 1, the liquid ejecting head further includes a pressure acquisition section that acquires the pressure of the first liquid chamber based on a resistance value of the first detection element. According to this, it is possible to acquire the pressure of the first liquid chamber even when the pressure of the liquid does not change. An example of a time when the pressure of the liquid does not change is when the liquid is only circulating and is not being ejected from the nozzle. Even when the liquid is not being ejected, it is possible to measure the pressure value of the first liquid chamber.

In Aspect 3 which is a specific example of Aspect 1, the first liquid chamber is a first dummy liquid chamber that communicates with a dummy nozzle that does not contribute to printing. According to this, since the first dummy liquid chamber can be filled with a liquid well, for example, when an initial filling process is carried out to fill the first dummy liquid chamber with a liquid in a state where the first dummy liquid chamber is not filled with a liquid, the first dummy liquid chamber and the dummy nozzle can be filled with a liquid well without leaving any air bubbles or the like.

In Aspect 4 which is a specific example of Aspect 1, the liquid ejecting head further includes an inlet for introducing a liquid into the first common liquid chamber, in which the plurality of pressure chambers have a second pressure chamber located at an end in a second direction which is an opposite direction to the first direction, and a distance from the inlet to the first pressure chamber is greater than a distance from the inlet to the second pressure chamber. According to this, when the first detection element is provided at one location in the liquid ejecting head, the first detection element is provided in the first liquid chamber located at the end farthest from the inlet. Since the pressure loss increases with increasing distance from the inlet, it is possible to detect the pressure of the first liquid chamber, which is located at a position where the pressure loss is larger.

In Aspect 5 which is a specific example of Aspect 1, the liquid ejecting head further includes an inlet for introducing a liquid into the first common liquid chamber, in which the plurality of pressure chambers have a second pressure chamber located at an end in a second direction which is an opposite direction to the first direction, and when viewed in an ejection direction in which the plurality of nozzles eject the liquid, the inlet is disposed between the first pressure chamber and the second pressure chamber in the first direction. According to this, compared to when the inlet is disposed outside the pressure chamber in the first direction, neither the first pressure chamber nor the second pressure chamber is significantly farther from the inlet than the other pressure chamber. In other words, the pressure loss in the first pressure chamber and the second pressure chamber at both ends is approximately the same, and it is possible to eliminate any pressure chamber with a significantly large pressure loss.

In Aspect 6 which is a specific example of Aspect 2, the liquid ejecting head further includes a second detection element for acquiring the pressure within the first liquid chamber, the second detection element corresponding to the first vibration plate, in which the pressure acquisition section acquires the pressure of the first liquid chamber based also on a resistance value of the second detection element. Since the pressure acquisition section acquires the pressure of the first liquid chamber based on the first detection element and the second detection element, the detection accuracy of the pressure of the first liquid chamber can be improved compared to a pressure acquisition section that acquires the pressure of the first liquid chamber based on the resistance value of a single first detection element.

In Aspect 7 which is a specific example of Aspect 1, the liquid ejecting head further includes: a second liquid chamber that is disposed in a second direction which is an opposite direction to the first direction with respect to a second pressure chamber located at an end of the plurality of pressure chambers in the second direction, and that is coupled to the first common liquid chamber; a second vibration plate that defines a portion of the second liquid chamber; and a second detection element for acquiring a pressure within the second liquid chamber, the second detection element corresponding to the second vibration plate. According to this, it is possible to detect the pressure in the first liquid chamber and the second liquid chamber.

In Aspect 8 which is a specific example of Aspect 1, the liquid ejecting head does not have a piezoelectric element corresponding to the first liquid chamber, but has a plurality of piezoelectric elements that apply a pressure to the plurality of pressure chambers. According to this, the first vibration plate is not interfered by the piezoelectric element, and therefore can be easily deformed. Since the first vibration plate is easily deformed by the pressure of the liquid, the pressure of the first liquid chamber can be detected with higher accuracy.

In Aspect 9 which is a specific example of Aspect 1, a width of the first vibration plate in the first direction is larger than a width of a vibration plate that defines a portion of the first pressure chamber in the first direction.

In Aspect 10 which is a specific example of Aspect 9, the liquid ejecting head further includes a plurality of individual flow paths coupled to the first common liquid chamber, in which the plurality of individual flow paths have a plurality of second individual flow paths that communicate with each of the plurality of nozzles and include each of the plurality of pressure chambers, and a first individual flow path including the first liquid chamber, and a width of the first individual flow path in a third direction intersecting the first direction and an ejection direction in which a liquid is ejected is equal to a width of the second individual flow path in the third direction.

In Aspect 11 which is a specific example of Aspect 1, the liquid ejecting head further includes: a plurality of second individual flow paths to which a liquid is supplied from the first common liquid chamber, the plurality of second individual flow paths communicating with each of the plurality of nozzles and including each of the plurality of pressure chambers; a second common liquid chamber for recovering the liquid that is not ejected from the plurality of nozzles from the plurality of second individual flow paths; and a first individual flow path that includes the first liquid chamber and couples the first common liquid chamber and the second common liquid chamber. According to this, it is possible to suppress increases in cost and size of the liquid ejecting head compared to a configuration in which a first detection element is provided to measure the pressure in each of the pressure chambers, and to prevent destruction of the meniscus in all nozzles. Furthermore, by providing a first liquid chamber on the first direction side of the first pressure chamber located at the end portion of the first direction among the plurality of pressure chambers, and providing a first detection element in that first liquid chamber, it is possible to dispose the nozzles that contribute to printing at equal intervals and with higher density compared to when they are provided at a place other than the end portion. Furthermore, in the liquid ejecting head, the liquid circulates from the first common liquid chamber through the first liquid chamber to the second common liquid chamber, thereby preventing the liquid in the first liquid chamber from thickening, and enabling pressure to be detected accurately.

According to Aspect 12 which is a preferred aspect, there is provided a liquid ejecting apparatus including: the liquid ejecting head according to Aspect 1; and a pressure acquisition section that acquires the pressure of the first liquid chamber based on a resistance value of the first detection element. The pressure acquisition section can be provided in the liquid ejecting apparatus instead of in the liquid ejecting head. Accordingly, it is possible to simplify the structure of the liquid ejecting head.

What is claimed is:

1. A liquid ejecting head comprising:
a plurality of nozzles that eject a liquid;
a plurality of pressure chambers to which a pressure for ejecting a liquid from each of the plurality of nozzles is applied and that are arranged in a first direction;
a first liquid chamber disposed in the first direction with respect to a first pressure chamber located at an end of the plurality of pressure chambers in the first direction;
a first vibration plate that defines a portion of the first liquid chamber;
a first common liquid chamber commonly coupled to the plurality of pressure chambers and the first liquid chamber; and
a first detection element for acquiring a pressure within the first liquid chamber, the first detection element corresponding to the first vibration plate.

2. The liquid ejecting head according to claim 1, further comprising:
a pressure acquisition section that acquires the pressure of the first liquid chamber based on a resistance value of the first detection element.

3. The liquid ejecting head according to claim 1, wherein
the first liquid chamber is a first dummy liquid chamber that communicates with a dummy nozzle that does not contribute to printing.

4. The liquid ejecting head according to claim 1, further comprising:
an inlet for introducing a liquid into the first common liquid chamber, wherein
the plurality of pressure chambers have a second pressure chamber located at an end in a second direction which is an opposite direction to the first direction, and
a distance from the inlet to the first pressure chamber is greater than a distance from the inlet to the second pressure chamber.

5. The liquid ejecting head according to claim 1, further comprising:
an inlet for introducing a liquid into the first common liquid chamber, wherein
the plurality of pressure chambers have a second pressure chamber located at an end in a second direction which is an opposite direction to the first direction, and
when viewed in an ejection direction in which the plurality of nozzles eject a liquid, the inlet is disposed between the first pressure chamber and the second pressure chamber in the first direction.

6. The liquid ejecting head according to claim 2, further comprising:
a second detection element for acquiring the pressure within the first liquid chamber, the second detection element corresponding to the first vibration plate, wherein
the pressure acquisition section acquires the pressure of the first liquid chamber based also on a resistance value of the second detection element.

7. The liquid ejecting head according to claim 1, further comprising:
a second liquid chamber that is disposed in a second direction which is an opposite direction to the first direction with respect to a second pressure chamber located at an end of the plurality of pressure chambers in the second direction, and that is coupled to the first common liquid chamber;
a second vibration plate that defines a portion of the second liquid chamber; and
a second detection element for acquiring a pressure within the second liquid chamber, the second detection element corresponding to the second vibration plate.

8. The liquid ejecting head according to claim 1, wherein
the liquid ejecting head does not have a piezoelectric element corresponding to the first liquid chamber, but has a plurality of piezoelectric elements that apply a pressure to the plurality of pressure chambers.

9. The liquid ejecting head according to claim 1, wherein
a width of the first vibration plate in the first direction is larger than a width of a vibration plate that defines a portion of the first pressure chamber in the first direction.

10. The liquid ejecting head according to claim 9, further comprising:
a plurality of individual flow paths coupled to the first common liquid chamber, wherein
the plurality of individual flow paths have
a plurality of second individual flow paths that communicate with each of the plurality of nozzles and include each of the plurality of pressure chambers, and
a first individual flow path including the first liquid chamber, and
a width of the first individual flow path in a third direction intersecting the first direction and an ejection direction in which a liquid is ejected is equal to a width of the second individual flow path in the third direction.

11. The liquid ejecting head according to claim 1, further comprising:
a plurality of second individual flow paths to which a liquid is supplied from the first common liquid chamber, the plurality of second individual flow paths communicating with each of the plurality of nozzles and including each of the plurality of pressure chambers;
a second common liquid chamber for recovering a liquid that is not ejected from the plurality of nozzles from the plurality of second individual flow paths; and
a first individual flow path that includes the first liquid chamber and couples the first common liquid chamber and the second common liquid chamber.

12. A liquid ejecting apparatus comprising:
the liquid ejecting head according to claim 1; and
a pressure acquisition section that acquires the pressure of the first liquid chamber based on a resistance value of the first detection element.
